(19) United States
(12) Patent Application Publication
(10) Pub. No.: US 2026/0312645 A1
(43) Pub. Date: Oct. 8, 2026

(54) METHODS, SYSTEMS, AND APPARATUSES FOR CHANNEL STATE INFORMATION ACKNOWLEDGMENT IN COORDINATED BEAMFORMING

(71) Applicant: Nokia Technologies Oy, Espoo (FI)

(72) Inventors: Orhan Okan MUTGAN, Munich (DE); Mikhail LIUBOGOSHCHEV, Munich (DE); Mario COSTA, Espoo (FI); Juhyung LEE, Santa Clara, CA (US); Kerstin JOHNSSON, Palo Alto, CA (US)

(21) Appl. No.: 19/170,730

(22) Filed: Apr. 4, 2025

(51) Int. Cl. H04B 7/06; H04L 5/00

(52) U.S. Cl. CPC H04B 7/0626; H04L 5/0055

(57) ABSTRACT

Methods, systems, apparatuses, and computer program products for providing channel state information (CSI) acknowledgment in coordinated beamforming of a communication network are disclosed herein. In an implementation, a null data packet is transmitted to a station device in response to initiation of channel sounding for a wireless channel by an access point device, CSI is received from the station device based on the null data packet, a CSI acknowledgment request is received from the access point device, and a CSI acknowledgment message associated with the channel sounding is transmitted based on the CSI acknowledgment request.

### TECHNICAL FIELD

Various example embodiments relate generally to communication systems and, more particularly, to wireless network functionality related to beamforming.

### BACKGROUND

Wireless communication networks, such as wireless fidelity (Wi-Fi) networks, may support latency-sensitive applications at Wi-Fi stations (STAs). Such latency-sensitive applications may include video applications, virtual reality (VR) applications, mixed reality (MR) applications, augmented reality (AR) applications, and extended reality (XR) applications. However, in some cases, interference associated with a wireless channel may constrain the performance of the latency-sensitive applications and/or the wireless communication network.

### BRIEF DESCRIPTION

According to some aspects, there is provided the subject matter of the independent claims. Some further aspects are defined in the dependent claims. The embodiments that do not fall under the scope of the claims are to be interpreted as examples useful for understanding the disclosure.

In an example embodiment, an apparatus is provided. In one or more embodiments, the apparatus comprises at least one processor and at least one memory storing instructions. In some embodiments, the instructions, when executed by the at least one processor, cause the apparatus to transmit a null data packet to a station device in response to initiation of channel sounding for a wireless channel by an access point device. In some embodiments, the instructions, when executed by the at least one processor, additionally or alternatively cause the apparatus to receive channel state information (CSI) from the station device based on the null data packet. In some embodiments, the instructions, when executed by the at least one processor, additionally or alternatively cause the apparatus to receive a CSI acknowledgment request from the access point device. In some embodiments, the instructions, when executed by the at least one processor, additionally or alternatively cause the apparatus to transmit a CSI acknowledgment message associated with the channel sounding based on the CSI acknowledgment request.

In some embodiments, the instructions, when executed by the at least one processor, additionally or alternatively cause the apparatus to transmit the CSI acknowledgment message to the access point device or the station device to (i) enable continuation of the channel sounding, (ii) initiate re-sounding associated with the CSI, or (iii) provide a recommend next action for the access point device.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, a Block Acknowledgment Request (BAR) frame, a null data packet announcement (NDPA) frame comprises the CSI acknowledgment request, a beamforming report poll (BFRP) frame comprises the CSI acknowledgment request, a management frame, a control frame, or a data frame comprises the CSI acknowledgment request.

In some embodiments, the instructions, when executed by the at least one processor, additionally or alternatively cause the apparatus to receive the CSI acknowledgment request from the access point device (i) in response to receiving the CSI from the station device, (ii) in response to completion of the channel sounding, or (iii) during a network process that is different than the channel sounding.

In another example embodiment, a method is provided. In some embodiments, the method comprises transmitting a null data packet to a station device in response to initiation of channel sounding for a wireless channel by an access point device. In some embodiments, the method additionally or alternatively comprises receiving channel state information (CSI) from the station device based on the null data packet. In some embodiments, the method additionally or alternatively comprises receiving a CSI acknowledgment request from the access point device. In some embodiments, the method additionally or alternatively comprises transmitting a CSI acknowledgment message associated with the channel sounding based on the CSI acknowledgment request.

In some embodiments, the method additionally or alternatively comprises transmitting the CSI acknowledgment message to the access point device or the station device to (i) enable continuation of the channel sounding, (ii) initiate re-sounding associated with the CSI, or (iii) provide a recommend next action for the access point device.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, a Block Acknowledgment Request (BAR) frame, a null data packet announcement (NDPA) frame comprises the CSI acknowledgment request, a beamforming report poll (BFRP) frame comprises the CSI acknowledgment request, a management frame, a control frame, or a data frame comprises the CSI acknowledgment request.

In some embodiments, the method additionally or alternatively comprises receiving the CSI acknowledgment request from the access point device (i) in response to receiving the CSI from the station device, (ii) in response to completion of the channel sounding, or (iii) during a network process that is different than the channel sounding.

In yet another example embodiment, a non-transitory computer-readable storage medium is provided. In some embodiments, the non-transitory computer-readable storage medium includes program instructions stored thereon that are configured to transmit a null data packet to a station device in response to initiation of channel sounding for a wireless channel by an access point device. In some embodiments, the non-transitory computer-readable storage medium additionally or alternatively includes program instructions stored thereon that are configured to receive channel state information (CSI) from the station device based on the null data packet. In some embodiments, the non-transitory computer-readable storage medium additionally or alternatively includes program instructions stored thereon that are configured to receive a CSI acknowledgment request from the access point device. In some embodiments, the non-transitory computer-readable storage medium additionally or alternatively includes program instructions stored thereon that are configured to transmit a CSI acknowledgment message associated with the channel sounding based on the CSI acknowledgment request.

In some embodiments, the non-transitory computer-readable storage medium additionally or alternatively includes program instructions stored thereon that are configured to transmit the CSI acknowledgment message to the access point device or the station device to (i) enable continuation of the channel sounding, (ii) initiate re-sounding associated with the CSI, or (iii) provide a recommend next action for the access point device.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, a Block Acknowledgment Request (BAR) frame, a null data packet announcement (NDPA) frame comprises the CSI acknowledgment request, a beamforming report poll (BFRP) frame comprises the CSI acknowledgment request, a management frame, a control frame, or a data frame comprises the CSI acknowledgment request.

In some embodiments, the non-transitory computer-readable storage medium additionally or alternatively includes program instructions stored thereon that are configured to receive the CSI acknowledgment request from the access point device (i) in response to receiving the CSI from the station device, (ii) in response to completion of the channel sounding, or (iii) during a network process that is different than the channel sounding.

In yet another example embodiment, an apparatus is provided. In some embodiments, the apparatus provides means for transmitting a null data packet to a station device in response to initiation of channel sounding for a wireless channel by an access point device. In some embodiments, the apparatus additionally or alternatively provides means for receiving channel state information (CSI) from the station device based on the null data packet. In some embodiments, the apparatus additionally or alternatively provides means for receiving a CSI acknowledgment request from the access point device. In some embodiments, the apparatus additionally or alternatively provides means for transmitting a CSI acknowledgment message associated with the channel sounding based on the CSI acknowledgment request.

In some embodiments, the apparatus additionally or alternatively provides means for transmitting the CSI acknowledgment message to the access point device or the station device to (i) enable continuation of the channel sounding, (ii) initiate re-sounding associated with the CSI, or (iii) provide a recommend next action for the access point device.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, a Block Acknowledgment Request (BAR) frame, a null data packet announcement (NDPA) frame comprises the CSI acknowledgment request, a beamforming report poll (BFRP) frame comprises the CSI acknowledgment request, a management frame, a control frame, or a data frame comprises the CSI acknowledgment request.

In some embodiments, the apparatus additionally or alternatively provides means for receiving the CSI acknowledgment request from the access point device (i) in response to receiving the CSI from the station device, (ii) in response to completion of the channel sounding, or (iii) during a network process that is different than the channel sounding.

In an example embodiment, an apparatus is provided. In one or more embodiments, the apparatus comprises at least one processor and at least one memory storing instructions. In some embodiments, the instructions, when executed by the at least one processor, cause the apparatus to control channel sounding for a wireless channel in coordination with an access point device. In some embodiments, the instructions, when executed by the at least one processor, additionally or alternatively cause the apparatus to transmit a channel state information (CSI) acknowledgment request to the access point device. In some embodiments, the instructions, when executed by the at least one processor, additionally or alternatively cause the apparatus to receive a CSI acknowledgment message from the access point device in response to the CSI acknowledgment request. In some embodiments, the instructions, when executed by the at least one processor, additionally or alternatively cause the apparatus to determine whether to continue the channel sounding for the wireless channel based on the CSI acknowledgment message.

In some embodiments, the instructions, when executed by the at least one processor, additionally or alternatively cause the apparatus to continue the channel sounding for the wireless channel based on a determination that the CSI acknowledgment message corresponds to a positive CSI acknowledgment.

In some embodiments, the instructions, when executed by the at least one processor, additionally or alternatively cause the apparatus to initiate resounding of the CSI based on a determination that the CSI acknowledgment message corresponds to a negative CSI acknowledgment.

In some embodiments, the instructions, when executed by the at least one processor, additionally or alternatively cause the apparatus to perform a next action based on a recommendation included in the CSI acknowledgment message.

In some embodiments, the instructions, when executed by the at least one processor, additionally or alternatively cause the apparatus to transmit the CSI to the access point device based on a determination that the CSI acknowledgment corresponds to a negative CSI acknowledgment.

In some embodiments, the instructions, when executed by the at least one processor, additionally or alternatively cause the apparatus to transmit the CSI acknowledgment request to the access point device via a Block Acknowledgment Request (BAR) frame, a null data packet announcement (NDPA) frame, or a beamforming report poll (BFRP) frame, a management frame, a control frame, or a data frame.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, the instructions, when executed by the at least one processor, additionally or alternatively cause the apparatus to transmit the CSI acknowledgment request to the access point device (i) in response to the access point device receiving the CSI from the station device, (ii) in response to completion of the channel sounding, or (iii) during a network process that is different than the channel sounding.

In another example embodiment, a method is provided. In some embodiments, the method comprises controlling channel sounding for a wireless channel in coordination with an access point device. In some embodiments, the method additionally or alternatively comprises transmitting a channel state information (CSI) acknowledgment request to the access point device. In some embodiments, the method additionally or alternatively comprises receiving a CSI acknowledgment message from the access point device in response to the CSI acknowledgment request. In some embodiments, the method additionally or alternatively comprises determining whether to continue the channel sounding for the wireless channel based on the CSI acknowledgment message.

In some embodiments, the method additionally or alternatively comprises continuing the channel sounding for the wireless channel based on a determination that the CSI acknowledgment message corresponds to a positive CSI acknowledgment.

In some embodiments, the method additionally or alternatively comprises initiating resounding of the CSI based on a determination that the CSI acknowledgment message corresponds to a negative CSI acknowledgment.

In some embodiments, the method additionally or alternatively comprises performing a next action based on a recommendation included in the CSI acknowledgment message.

In some embodiments, the method additionally or alternatively comprises transmitting the CSI to the access point device based on a determination that the CSI acknowledgment corresponds to a negative CSI acknowledgment.

In some embodiments, the method additionally or alternatively comprises transmitting the CSI acknowledgment request to the access point device via a Block Acknowledgment Request (BAR) frame, a null data packet announcement (NDPA) frame, or a beamforming report poll (BFRP) frame, a management frame, a control frame, or a data frame.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, the method additionally or alternatively comprises transmitting the CSI acknowledgment request to the access point device (i) in response to the access point device receiving the CSI from the station device, (ii) in response to completion of the channel sounding, or (iii) during a network process that is different than the channel sounding.

In yet another example embodiment, a non-transitory computer-readable storage medium is provided. In some embodiments, the non-transitory computer-readable storage medium includes program instructions stored thereon that are configured to control channel sounding for a wireless channel in coordination with an access point device. In some embodiments, the non-transitory computer-readable storage medium additionally or alternatively includes program instructions stored thereon that are configured to transmit a channel state information (CSI) acknowledgment request to the access point device. In some embodiments, the non-transitory computer-readable storage medium additionally or alternatively includes program instructions stored thereon that are configured to receive a CSI acknowledgment message from the access point device in response to the CSI acknowledgment request. In some embodiments, the non-transitory computer-readable storage medium additionally or alternatively includes program instructions stored thereon that are configured to determine whether to continue the channel sounding for the wireless channel based on the CSI acknowledgment message.

In some embodiments, the non-transitory computer-readable storage medium additionally or alternatively includes program instructions stored thereon that are configured to continue the channel sounding for the wireless channel based on a determination that the CSI acknowledgment message corresponds to a positive CSI acknowledgment.

In some embodiments, the non-transitory computer-readable storage medium additionally or alternatively includes program instructions stored thereon that are configured to initiate resounding of the CSI based on a determination that the CSI acknowledgment message corresponds to a negative CSI acknowledgment.

In some embodiments, the non-transitory computer-readable storage medium additionally or alternatively includes program instructions stored thereon that are configured to perform a next action based on a recommendation included in the CSI acknowledgment message.

In some embodiments, the non-transitory computer-readable storage medium additionally or alternatively includes program instructions stored thereon that are configured to transmit the CSI to the access point device based on a determination that the CSI acknowledgment corresponds to a negative CSI acknowledgment.

In some embodiments, the non-transitory computer-readable storage medium additionally or alternatively includes program instructions stored thereon that are configured to transmit the CSI acknowledgment request to the access point device via a Block Acknowledgment Request (BAR) frame, a null data packet announcement (NDPA) frame, or a beamforming report poll (BFRP) frame, a management frame, a control frame, or a data frame.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, the non-transitory computer-readable storage medium additionally or alternatively includes program instructions stored thereon that are configured to transmit the CSI acknowledgment request to the access point device (i) in response to the access point device receiving the CSI from the station device, (ii) in response to completion of the channel sounding, or (iii) during a network process that is different than the channel sounding.

In yet another example embodiment, an apparatus is provided. In some embodiments, the apparatus provides means for controlling channel sounding for a wireless channel in coordination with an access point device. In some embodiments, the apparatus additionally or alternatively provides means for transmitting a channel state information (CSI) acknowledgment request to the access point device. In some embodiments, the apparatus additionally or alternatively provides means for receiving a CSI acknowledgment message from the access point device in response to the CSI acknowledgment request. In some embodiments, the apparatus additionally or alternatively provides means for determining whether to continue the channel sounding for the wireless channel based on the CSI acknowledgment message.

In some embodiments, the apparatus additionally or alternatively provides means for continuing the channel sounding for the wireless channel based on a determination that the CSI acknowledgment message corresponds to a positive CSI acknowledgment.

In some embodiments, the apparatus additionally or alternatively provides means for initiating resounding of the CSI based on a determination that the CSI acknowledgment message corresponds to a negative CSI acknowledgment.

In some embodiments, the apparatus additionally or alternatively provides means for performing a next action based on a recommendation included in the CSI acknowledgment message.

In some embodiments, the apparatus additionally or alternatively provides means for transmitting the CSI to the access point device based on a determination that the CSI acknowledgment corresponds to a negative CSI acknowledgment.

In some embodiments, the apparatus additionally or alternatively provides means for transmitting the CSI acknowledgment request to the access point device via a Block Acknowledgment Request (BAR) frame, a null data packet announcement (NDPA) frame, or a beamforming report poll (BFRP) frame, a management frame, a control frame, or a data frame.

In some embodiments, the CSI acknowledgment request comprises at least one of the following: a station identifier for the station device, an identifier for the apparatus, or an access point identifier for the access point device.

In some embodiments, the CSI acknowledgment request comprises a session identifier for the channel sounding.

In some embodiments, the CSI acknowledgment request comprises a CSI acknowledgment policy for the channel sounding.

In some embodiments, the CSI acknowledgment policy indicates criteria for transmission of the CSI acknowledgment message.

In some embodiments, the apparatus additionally or alternatively provides means for transmitting the CSI acknowledgment request to the access point device (i) in response to the access point device receiving the CSI from the station device, (ii) in response to completion of the channel sounding, or (iii) during a network process that is different than the channel sounding.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 depicts an example communication system in which one or more example embodiments of the present disclosure may be performed;

FIG. 2 is a block diagram of an apparatus configured in accordance with one or more example embodiments of the present disclosure;

FIG. 3 illustrates an example signaling flow diagram in accordance with one or more example embodiments of the present disclosure;

FIG. 4 illustrates example transmissions in accordance with one or more example embodiments of the present disclosure;

FIG. 5 illustrates example transmissions in accordance with one or more example embodiments of the present disclosure;

FIG. 6 illustrates an example format for a channel state information (CSI) acknowledgment message in accordance with one or more example embodiments of the present disclosure;

FIG. 7 illustrates an example format for a CSI acknowledgment request and a CSI acknowledgment message in accordance with one or more example embodiments of the present disclosure;

FIG. 8 illustrates an example format for a CSI acknowledgment request in accordance with one or more example embodiments of the present disclosure;

FIG. 9 illustrates another example format for a CSI acknowledgment request in accordance with one or more example embodiments of the present disclosure;

FIG. 10 illustrates an example format for a CSI acknowledgment message in accordance with one or more example embodiments of the present disclosure;

FIG. 11 illustrates another example format for a CSI acknowledgment request and a CSI acknowledgment message in accordance with one or more example embodiments of the present disclosure;

FIG. 12 illustrates another example format for a CSI acknowledgment request and a CSI acknowledgment message in accordance with one or more example embodiments of the present disclosure;

FIG. 13 illustrates another example format for a CSI acknowledgment request and a CSI acknowledgment message in accordance with one or more example embodiments of the present disclosure;

FIG. 14 illustrates another example format for a CSI acknowledgment request and a CSI acknowledgment message in accordance with one or more example embodiments of the present disclosure;

FIG. 15 illustrates another example format for a CSI acknowledgment request and a CSI acknowledgment message in accordance with one or more example embodiments of the present disclosure;

FIG. 16 illustrates another example format for a CSI acknowledgment request and a CSI acknowledgment message in accordance with one or more example embodiments of the present disclosure;

FIG. 17 illustrates a flowchart illustrating operations performed, such as by the apparatus of FIG. 2, in order to enable CSI acknowledgment in coordinated beamforming of a communication network, in accordance with one or more example embodiments of the present disclosure;

FIG. 18 illustrates another flowchart illustrating operations performed, such as by the apparatus of FIG. 2, in order to enable CSI acknowledgment in coordinated beamforming of a communication network, in accordance with one or more other example embodiments of the present disclosure;

FIG. 19 illustrates another flowchart illustrating operations performed, such as by the apparatus of FIG. 2, in order to enable CSI acknowledgment in coordinated beamforming of a communication network, in accordance with one or more other example embodiments of the present disclosure;

FIG. 20 illustrates another flowchart illustrating operations performed, such as by the apparatus of FIG. 2, in order to enable CSI acknowledgment in coordinated beamforming of a communication network, in accordance with one or more other example embodiments of the present disclosure;

FIG. 21 illustrates another flowchart illustrating operations performed, such as by the apparatus of FIG. 2, in order to enable CSI acknowledgment in coordinated beamforming of a communication network, in accordance with one or more other example embodiments of the present disclosure; and

FIG. 22 illustrates another flowchart illustrating operations performed, such as by the apparatus of FIG. 2, in order to enable CSI acknowledgment in coordinated beamforming of a communication network, in accordance with one or more other example embodiments of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means any, some or all of the following instances: (A), (B), or (A and B). For the purposes of the present disclosure, the phrase “A, B, and/or C” means any, some or all of the following instances: (A), (B), (C), (A and B), (A and C), (B and C), or (A, B, and C).

Some embodiments of the present disclosure will now be described more fully hereinafter with reference to the accompanying drawings, in which some, but not all, embodiments of the present disclosure are shown. Indeed, various embodiments of the present disclosure may be embodied in many different forms and should not be construed as limited to the certain embodiments set forth herein; rather, these certain embodiments are provided so that this disclosure will satisfy applicable legal requirements. Like reference numerals refer to like elements throughout.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the terms “data,” “content,” “information,” and similar terms may be used interchangeably to refer to data capable of being transmitted, received and/or stored in accordance with an embodiment of the present disclosure. Thus, use of any such terms should not be taken to limit the spirit and scope of one or more embodiments of the present disclosure.

A communications system may be deployed in a wireless local area network (e.g., WLAN, Wi-Fi, etc.), for example, based on IEEE 802.11 standards and/or related drafts, such as 802.11-2020, 802.11n, 802.11ac, 802.11ax, 802.11be, 802.11bn, and/or others. That is, the system may be an example of a WLAN system. The WLAN system may support wireless communications between one or more communications devices in accordance with one or more Wi-Fi protocols. In some examples, Wi-Fi communications may occur via one or more radio frequency bands, such as about a 2.4 GHz radio frequency band, a 5 GHz radio frequency band, a 6 GHz radio frequency band, and/or another radio frequency band. In some such examples, each radio frequency band may support one or more channels over which data may be communicated. In some examples, multiple devices may use multiple channels to communicate over the WLAN simultaneously.

A WLAN system may include one or more communications devices, such as one or more access points (APs) and/or one or more non-AP stations (STAs). That is, a device configured to support one or more Wi-Fi protocols may be an example of an AP (e.g., may operate in accordance with an AP mode) and/or may be an example of a STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID).

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity which may be configured to act as a network manager. In some examples, the network manager is an entity in cloud-based entity which may reside either in private cloud or in public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more non-AP STAs (also referred to as clients) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a non-AP STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDUs, wherein a payload of a PDU may comprise user data, control data, management data, and/or other data. In some examples, a WLAN system may implement one or more security protocols to protect the confidentiality, integrity, and availability of Wi-Fi communications.

A WLAN system may be configured with various types of services sets, for example, such as basic service set (BSS) and/or an extended service set (ESS). A BSS may be comprised of an AP and one or more client devices (e.g., non-AP STAs) associated with the AP. The one or more client devices may have one or more common PHY medium access characteristics (e.g., radio frequency, modulation scheme, security settings, and/or the like). A BSS identifier (BSSID) may define the BSS such that the one or more client devices of the BSS share the same BSSID.

A communication network such as a WLAN may support latency-sensitive applications at Wi-Fi stations (STAs). Such latency-sensitive applications may include video applications, virtual reality (VR) applications, mixed reality (MR) applications, augmented reality (AR) applications, and extended reality (XR) applications. Latency-sensitive applications may also include applications that utilize sensors which detect events to be reported with low latency. However, in some cases, interference associated with a wireless channel may constrain the performance of the latency-sensitive applications and/or a communication network (e.g., a WLAN, a WiFi network that utilizes IEEE 802.11 standards, etc.).

As an example, coordinated beamforming with null steering may occur in a communication network where multiple APs arrange respective transmissions in a way such that each AP directs a respective transmission to its own STA while creating nulls (e.g., to avoid interference) towards the STAs of the other APs. However, in a scenario with an AP1, STA1, AP2 and STA2, when AP1 transmits towards STA1 (e.g., through a wireless channel H11), interference may occur towards STA2 (e.g., through a wireless channel H12). Similarly, when AP2 transmits towards STA2 (e.g., through wireless channel H22), interference may occur towards STA1 (e.g., through wireless channel H21). As such, by utilizing coordinated beamforming, the interference channels (e.g., H12 and H21) may be nulled. For example, AP1 and AP2 may arrange their transmissions towards their STA (e.g., AP1 to STA1 and AP2 to STA2) in a way that STA1 only receives transmissions from AP1 and STA2 only receives transmissions from AP2. In other words, STA1 hears “null” from AP2, and STA2 hears “null” from AP1, where null refers to hearing nothing besides the noise floor via a wireless channel.

To achieve this, both AP1 and AP2 may utilize precoding vectors by taking into account their corresponding interference channels. In particular, AP1 and AP2 may acquire channel state information (CSI) from both STA1 and STA2. For example, if AP1 knows the CSI of the wireless channel H11 and the CSI of the wireless channel H12, AP1 may calculate the precoding vector so that AP1's transmissions only go to STA1 (e.g., its own STA) while creating null (e.g., avoiding interference) towards STA2. Similarly, if AP2 knows the CSI of the wireless channel H22 and the CSI of the wireless channel H21, AP2 may calculate the precoding vector so that AP2's transmissions only go to STA2 (e.g., its own STA) while creating null (e.g., avoiding interference) towards STA1.

For a STA to acquire CSI, channel sounding may be performed. Channel sounding may be a process for estimating and collecting information regarding a wireless channel (e.g., such as CSI) between a transmitter (e.g., an access point) and a receiver (e.g., a client station). For current WiFi communications systems, channel sounding is defined between a single AP and single/multiple stations associated to that AP. For channel sounding related to a single station, channel sounding may start with the AP sending a Null Data Packet Announcement (NDPA). After the NDPA, the AP may send a Null Data Packet (NDP). The STA then returns its CSI as measured during the NDP. For channel sounding related to multiple stations, channel sounding may start with the AP sending an NDPA, after which it sends an NDP. STA1 may then sends back its CSI in response to the NDP, after which the AP polls each STA using a Beamforming Report Poll (BFRP) to request that the STAs send their CSIs. For coordinated beamforming (CBF), multiple stations for channel sounding is needed.

While the channel sounding procedure varies slightly across 802.11 generations (11n, 11ac, 11ax, 11be, etc.), each channel sounding solution may utilize a MAC frame. However, the MAC frame format to carry CSI changes depending on the 802.11 generation, as shown in the below Table 1:

TABLE 1

| Wi-Fi | |
|---|---|
| Generation | CSI is carried in: |
| 802.11n | (non-)compressed beamforming frame |
| 802.11ac | Very High Throughput (VHT) compressed |
| | beamforming frame |
| 802.11ax | High Efficiency (HE) compressed beamforming/ |
| | channel quality indicator (CQI) frame |
| 802.11be | Extremely High Throughput (EHT) compressed |
| | beamforming/CQI frame |

Each frame defined in Table 1 may be an action frame (e.g., a category of management frames) and may be configured based on a Management Frame Format. For example, an Address 1 field of the action frame may be the RA (=DA) and is the destination address of the frame (e.g., the MAC address of the receiving STA or MAC address of the receiving AP), the Address 2 field of the action frame may be the TA (=SA) and is the address of the STA or AP transmitting the frame (e.g., the MAC address of the transmitting STA or MAC address of the transmitting AP), and the Address 3 field of the action frame may be the BSSID of the BSS of the intended recipient(s) (e.g., the MAC address of the AP).

In sequential channel sounding, STAs are sounded separately. APs transmit their NDPs sequentially and each STA sends its CSI to the relevant AP sequentially. Then, upon receiving BFRP trigger frame, STA1 first sends H11 to AP1 (e.g., with EHT Compressed Beamforming/CQI frame), then H21 to AP2 (e.g., with TBD Compressed Beamforming/CQI frame). Likewise, upon receiving BFRP trigger frame, STA2 first sends H22 (e.g., with EHT Compressed Beamforming/CQI frame) to AP2, then H12 (e.g., with TBD Compressed Beamforming/CQI) to AP1. In joint channel sounding, APs transmit their NDPs concurrently and listen for each STA's CSI frame concurrently. In other words, AP1 and AP2 transmit an NDP at the same time. Then, upon receiving BFRP trigger frame, STA1 sends H11 and H21 (e.g., with TBD Compressed Beamforming/CQI frame) to both AP1 and AP2. Likewise, upon receiving BFRP trigger frame, STA2 sends H12 and H22 (e.g., with TBD Compressed Beamforming/CQI) to both AP1 and AP2. As such, STA1 may be associated with AP1 and not associated with AP2. Similarly, STA2 may be associated with AP2 and not associated with AP1. Regardless of whether sequential or joint channel sounding is utilized, AP1 will have H11 and H12, and AP2 will have H21 and H22. With this CSI, AP1 and AP2 may perform CBF (e.g., transmitting towards their own users while avoiding interference towards STAs of the other AP).

In an example where both sequential and joint channel sounding utilize the EHT Compressed Beamforming/CQI frame for CSI, the EHT Compressed Beamforming/CQI frame is a no-ACK management (action) frame such that the AP does not send an acknowledgment (ACK) regardless of whether it receives the frame. Additionally, the AP may request the STA to retransmit CSI through re-sounding mechanisms (e.g., re-sending NDPA/NDP+BFRP). However, in sequential and joint channel sounding, a single AP (e.g., AP1) controls the sounding frames on behalf of another AP (e.g., AP2). Since, for example, while AP1 manages the sounding frames, it has the sole authority to initiate re-sounding of the STA1, while AP2 cannot independently request re-sounding of the STA1. As a result, if AP2 fails to correctly receive CSI (and subsequently, no ACK is sent) and cannot initiate re-sounding of the STA1, AP1 assumes that AP2 has received the CSI correctly. Consequently, CBF transmission (e.g., after the sounding) occurs with AP2 using incorrect CSI, resulting in transmission errors and disrupting CBF operations for a communication network.

In sequential channel sounding, EHT TB sounding and Cross-BSS UHR TB sounding may be utilized. For EHT TB sounding, if AP1 fails to receive CSI correctly, it can re-sound STA1 (e.g., re-send NDPA/NDP+BFRP), prompting STA1 to retransmit CSI. Similarly, if AP2 does not receive CSI correctly, it can re-sound STA2, prompting STA2 to retransmit CSI. However, for Cross-BSS UHR TB sounding, if AP2 does not receive CSI correctly, it cannot re-sound STA1, as AP1 controls STA1's re-sounding (e.g., with NDPA+BFRP). Similarly, if AP1 does not receive CSI correctly, it cannot re-sound STA2, as AP2 controls STA2's re-sounding (e.g., with NDPA+BFRP). In joint channel sounding, the no-ACK mechanism also fails. For example, if AP2 does not receive CSI correctly, it cannot re-sound STA1, as AP1 controls STA1's re-sounding. Likewise, if AP1 does not receive CSI correctly, it cannot re-sound STA2, as AP2 controls STA2's re-sounding. As such, it is desirable to improve management of CSI for channel sounding related to sequential channel sounding and/or joint channel sounding of a communication network (e.g., a WiFi communication network).

Described herein are apparatuses, methods, and computer program products for providing CSI acknowledgment in coordinated beamforming of a communication network to resolve some or all of the described limitations of current communication networks and/or current network protocols. For example, CSI acknowledgment may be utilized in a communication network for sequential channel sounding and/or join channel sounding. In various embodiments, the CSI acknowledgment message may be utilized for Cross-BSS UHR TB sounding related to a communication network.

In some embodiments related to sequential channel sounding, CSI provided from STA1 to AP2 may be acknowledged by AP2 while AP1 controls the channel sounding frames. If CSI is positively acknowledged, the channel sounding procedure may continue. If CSI is negatively acknowledged, AP1 may request re-sounding of CSI from STA1 to AP2 on behalf of the AP2.

In some embodiments related to sequential channel sounding, CSI provided from STA2 to AP1 may be acknowledged by AP1 while AP2 controls the sounding frames. If CSI is positively acknowledged, the channel sounding procedure may continue. If CSI is negatively acknowledged, AP2 may request re-sounding of CSI from STA2 to AP1 on behalf of the AP1.

In some embodiments related to joint channel sounding, CSI provided from STA1 to AP2 (and AP1) may be acknowledged by AP2 while AP1 controls the sounding frames. If CSI is positively acknowledged, the channel sounding procedure may continue. If CSI is negatively acknowledged, AP1 may request re-sounding of CSI from STA1 to AP2 on behalf of the AP2.

In some embodiments related to joint channel sounding, CSI provided from STA2 to AP1 (and AP2) is acknowledged by AP1 while AP2 controls the sounding frames. If CSI is positively acknowledged, the channel sounding procedure may continue. If CSI is negatively acknowledged, AP2 may request re-sounding of CSI from STA2 to AP1 on behalf of the AP1.

In some embodiments, a CSI ACK request may be provided from a controlling AP to a coordinating AP of a channel sounding process. In some embodiments, a CSI ACK response from the coordinating AP may indicate a positive or negative CSI ACK via direct CSI ACK transmission from the coordinating AP to the controlling AP. In some embodiments, a CSI ACK response from the coordinating AP may indicate a positive or negative CSI ACK via CSI ACK transmission from the coordinating AP to a STA that sends CSI, which is overheard by the controlling AP. The controlling AP may be an AP that sends NDPA and BFRP. The coordinating AP may be an AP that receives CSI from the STA triggered by the controlling AP with BFRP.

In some embodiments, a CSI acknowledgment policy may be defined for sequential channel sounding and/or join channel sounding. For example, the CSI acknowledgment policy may specify when and how CSI acknowledgment should occur for sequential channel sounding and/or join channel sounding, including different acknowledgment modes (e.g., positive/negative, immediate/delayed, cumulative/per-link). The CSI acknowledgment policy may enable for adaptive handling based on network conditions, such as threshold-based, retry-based, prioritized, and time-sensitive acknowledgments.

In some embodiments, CSI may be transmitted directly over the air. In some embodiments, CSI may be transmitted from the STA (e.g., STA1) to its associated (coordinating) AP (e.g., AP1) and then forwarded to the controlling AP (e.g., AP2).

In some embodiments, a control frame such as BAR, NDPA, or BFRP may be utilized for a CSI ACK request. In some embodiments, a new frame such as a new management (action) frame, control frame (new trigger or new specific control frame), or data frame may be utilized for a CSI ACK request.

In some embodiments, a control frame such as NDPA, ACK or BA may be utilized for a CSI ACK response. In some embodiments, a new frame such as a new management (action) frame, control frame (new trigger or new specific control frame), or data frame may be utilized for a CSI ACK response.

In some embodiments, a CSI ACK request and a CSI ACK response may be implemented using different combinations of the aforementioned frame types. For example, a CSI ACK request may be a trigger frame and the CSI ACK response may be a management frame.

Accordingly, with the CSI acknowledgment message in coordinated beamforming disclosed herein, interference associated with a wireless channel may be mitigated and/or reduced. Additionally, with the CSI acknowledgment message in coordinated beamforming disclosed herein, resource utilization associated with a communication network may be improved and/or latency associated with a data channel may be reduced, thereby improving performance of stations and/or latency-sensitive applications. The CSI acknowledgment message in coordinated beamforming disclosed herein may also provide improved performance, accuracy, and/or functionality for an access point associated with a communication network. Efficiency and/or network connectivity for a communication network can also be improved. For example, overall network signaling and/or data load of a data channel can be reduced to provide improved resiliency, network latency, and/or network speeds provided by a communication network. Moreover, tail latency associated with a communication network may also be minimized by utilizing the CSI acknowledgment message in coordinated beamforming disclosed herein.

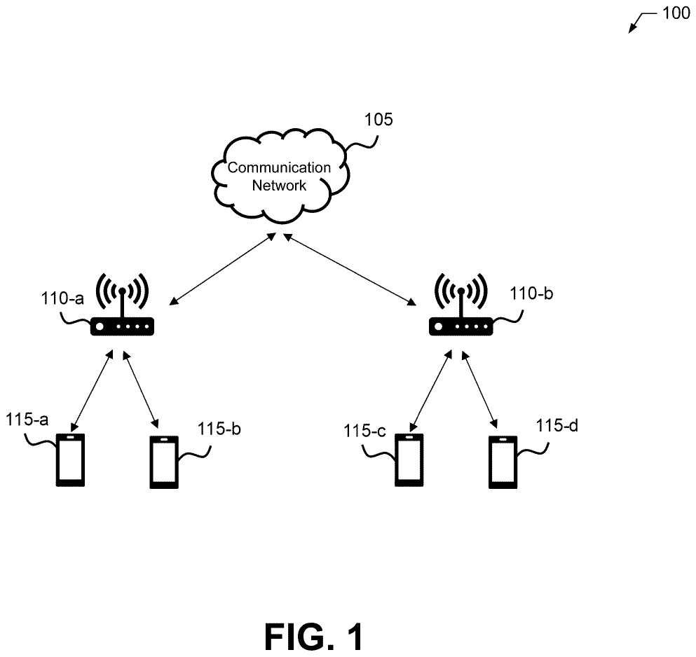

Referring now to FIG. 1, an example communication system 100 is illustrated according to one or more embodiments of the present disclosure. The communication system 100 is a communication system to which one or more examples disclosed herein may be applied. The depiction of the communication system 100 in FIG. 1 is not intended to limit or otherwise confine the example embodiment described and contemplated herein to any particular configuration of elements or systems, nor is it intended to exclude any alternative configurations or systems for the set of configurations and systems that can be used in connection with an example embodiment of the present disclosure. Rather, FIG. 1, and the communication system 100 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

The communication system 100 includes a communication network 105, one or more access points (APs) 110 (e.g., an AP 110a and an AP 110-b), and one or more stations (STAs) 115 (e.g., STA 115-a, STA 115-b, STA 115-c, and STA 115-d). The communication system 100 is a type of network where at least one link is wireless, and provides voice, video, and/or data services to a plurality of devices. The communication network 105 may be a wireless communication network, a wireless local area network, a Wi-Fi network, or another type of communication network. The communication network 105 is illustrated as providing communication services to the one or more STA 115 via the one or more APs 110. The one or more STA 115 may be enabled for voice services, video services, data services, VR services, MR services, AR services, XR services, Internet of Things (IoT) services, and/or one or more other services. In some embodiments, the communication network 100 or components thereof can be configured to communicate with the one or more STA 115 and/or the one or more APs 110 over multiple different frequency bands, sub-bands thereof, and/or the like.

The one or more STAs 115 may be one or more client devices, such as one or more non-AP STAs, connected to the one or more APs 110. For example, the STA 115-a and the STA 115-b may be connected to the AP 110-a. Additionally, the STA 115-c and the STA 115-d may be connected to the AP 110-b. In some examples, the one or more APs 110 may be mobile access points (mAPs) with controlled network functionality. In such examples, a configuration comprising a mAP and a STA may be implemented based on Wi-Fi Direct or another type of network connection. In some examples, a device may simultaneously operate as a non-AP STA and as an AP. One such an example case is in a multi-AP network, which includes two or more devices that may act as APs and use Wi-Fi for the wireless backhaul connectivity based on a non-AP STA-AP connection model. In some examples, a device may simultaneously operate as part of a peer-to-peer connection based on Wi-Fi Direct or Wi-Fi Aware.

In some embodiments, communication between the one or more STAs 115 and the one or more APs 110 may provide the one or more STAs 115 access to the communication network 105 and/or may enable communication therewith. In some embodiments, the one or more APs 110 may provide wireless connectivity for the one or more STAs 115 according to the Wi-Fi standards, such as those that are a subset of the IEEE 802 family of standards. For example, the one or more APs 110 may provide wireless connectivity for the one or more STAs 115 according to the MAC and PHY specifications for Wi-Fi access points defined by IEEE 802.11 for transmitting and receiving data in frequency bands such as 2.4 GHz, 3.6 GHz, 5 GHz, 6 GHz, 60 GHz, and/or the like. The one or more APs 110 and the one or more STAs 115 may communicate through the transmission of frames, including data frames, beacon frames, management frames, and/or control frames, which may be transmitted in unicast messages, broadcast messages, or multicast messages. The 802.11 standards define an inter-frame space (IFS) as the nominal time (in microseconds (μs)) that the MAC and PHY use to receive the last symbol of a frame, process the frame, and respond with the first symbol of a response frame (e.g., the earliest possible response frame). In some embodiments, one or more STAs 115 may be configured to be in a wireless connection with at least one Wi-Fi AP (e.g., AP 110). It is to be appreciated that a Wi-Fi AP may be implemented by various entities and/or types of entities, for example, such as APs, mAPs, access nodes, nodes, hosts, servers, base stations, and/or other entities suitable for such usage.

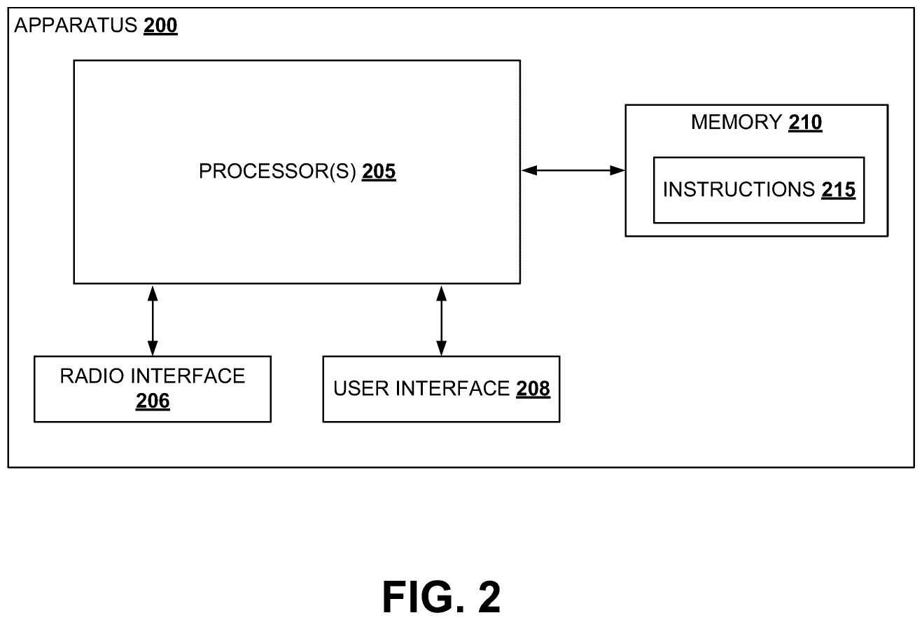

In some examples, the communication system 100 may support radio frequency sensing during IFS. In some examples, the communication system 100 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. In some embodiments, the transceiver may include a processor and/or a memory (e.g., such as processor 205 and/or memory 210, further described with respect to FIG. 2). The processor 205 may be used to execute instructions stored in the memory 210 and/or to store information in the memory 210, for example, such as the results of the executed instructions.

The one or more APs 110 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver. In some embodiments, the transceiver of an AP 110 may include a processor and/or a memory (e.g., such as processor 205 and/or memory 210, further described with respect to FIG. 2).

An STA of the one or more STAs 115 may be a client device such as, for example, a client-side user device, a non-AP STA, user equipment (UE), and/or another type of entity configured to communicate with the one or more APs 110. A UE may be a mobile terminal, such as a mobile phone, a smartphone, a pager, a mobile television, a gaming device, a laptop computer, a computer with a mobile broadband adapter, a camera, a tablet computer, a portable digital assistant (PDA), a communicator, pad, a wearable device, a headset, a touch surface, a video recorder, an audio/video player, radio, an electronic book, a positioning device (e.g., global positioning system (GPS) device), a virtual reality device, an augmented reality device, or any combination of the aforementioned. In some embodiments, an AP 110 may include a processor and/or a memory (e.g., such as processor 205 and/or memory 210, further described with respect to FIG. 2).

In some embodiments, the communication system 100 may support latency-sensitive applications at Wi-Fi devices such as the one or more APs 110 and the one or more STAs 115. Such latency-sensitive applications may include virtual reality applications, mixed reality applications, augmented reality applications, and extended reality applications.

In one or more embodiments, CSI acknowledgment in coordinated beamforming associated with the communication system 100 and/or the communication network 105 may be enabled by employing an apparatus 200 as depicted in FIG. 2. The apparatus 200 may be embodied by and/or incorporated into an AP (e.g., the one or more APs 110), an STA (e.g., the one or more STAs 115), and/or another device discussed with respect to FIG. 1.

Regardless of the manner in which the apparatus 200 is embodied, the apparatus 200 includes, is associated with, and/or is in communication with: at least one processor 205, at least one memory 210, and a communication interface 215. In one or more embodiments, the apparatus 200 comprises, for example, the at least one processor 205 and the at least one memory 210 storing instructions 215 that, when executed by the at least one processor 205, cause the apparatus 200 at least to perform the method or methods as disclosed herein, and any of the embodiments thereof. In an example, the at least one memory 210 and the instructions 215 (e.g., a computer program code, software), are configured, with the at least one processor 205, to cause the apparatus 200 to perform the method or methods as disclosed herein, and any of the embodiments thereof.

In some embodiments, the processor 205 may be in communication with the memory 210 via a bus for passing information among components of the apparatus 200. The memory 210 may be non-transitory and may include, for example, one or more volatile and/or non-volatile memories. In other words, for example, the memory 210 may be an electronic storage device (e.g., a computer readable storage medium) comprising gates configured to store data (e.g., bits) that may be retrievable by a machine (e.g., a computing device like the processor). The memory 210 may be configured to store information, data, content, applications, instructions, or the like for enabling the apparatus to carry out various functions in accordance with an example embodiment of the present disclosure. For example, the memory 210 could be configured to buffer input data for processing by the processor. Additionally or alternatively, the memory 210 may be configured to store instructions for execution by the processor 205.

The processor 202 may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 210 may be implemented using any suitable data storage technology. The memory may comprise a database for storing data. The memory 210 may be at least in part external to apparatus 200 but accessible to apparatus 200.

The instructions 215 may be comprised in a computer readable medium or a non-transitory computer readable medium. A term non-transitory, as used herein, is a limitation of the medium itself (e.g., tangible, not a signal) as opposed to a limitation on data storage persistency (e.g., random access memory, RAM, vs. read only memory, ROM).

The apparatus 200 comprises a radio interface 206. The radio interface 206 may provide the apparatus 200 with communication capabilities. The radio interface 206 may comprise a receiver configured to receive information in accordance with at least one cellular or non-cellular standard. The radio interface 206 may comprise a transmitter configured to transmit information in accordance with at least one cellular or non-cellular standard. The receiver may comprise more than one receiver. The transmitter may comprise more than one transmitter. The radio interface 206 may comprise a transceiver configured to receive and transmit information in accordance with at least one cellular or non-cellular standard. The transceiver may comprise more than one transceiver.

The apparatus 200 may optionally comprise a user interface 208 comprising, for example, at least one of a keypad, a microphone, a touch display, a display, a speaker, etc. The user interface 208 may be used to control the apparatus by the user. The user interface 208 may be external to the apparatus 200. For example, the apparatus 200 may be connected to another device, such as a computer, either via wireless or wired connection, and the apparatus 200 is controlled by the user via the computer.

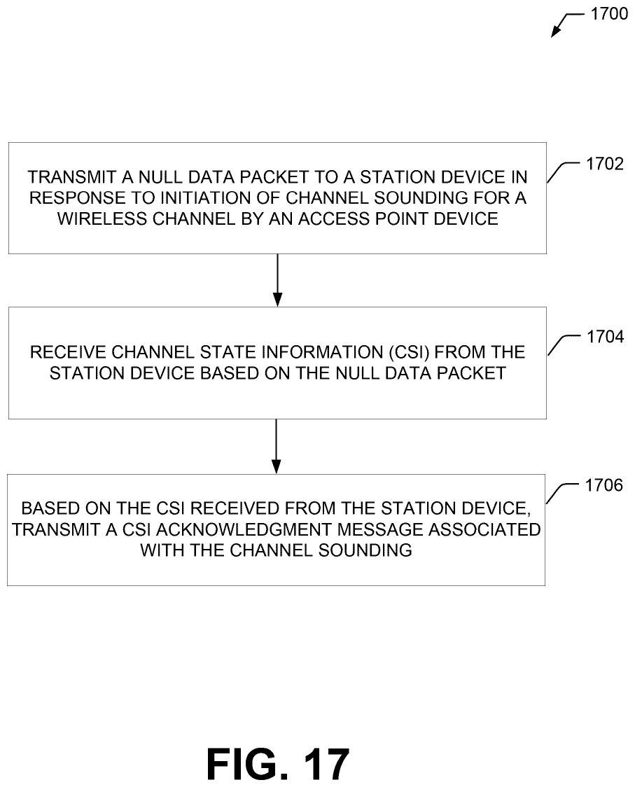

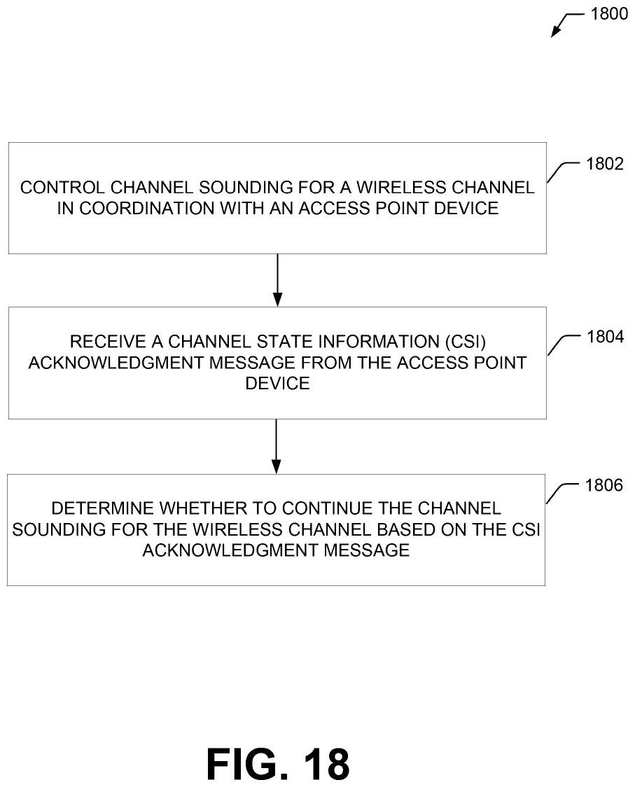

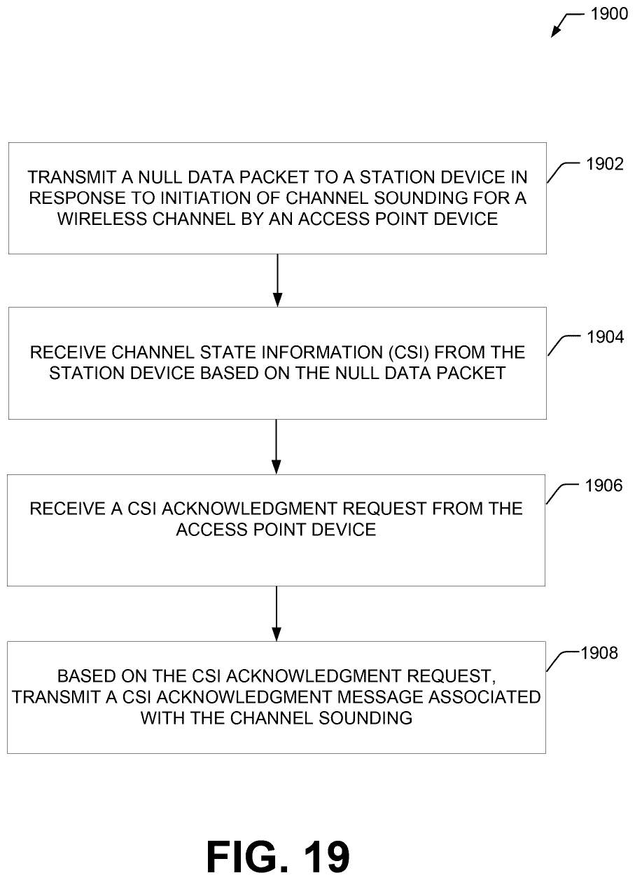

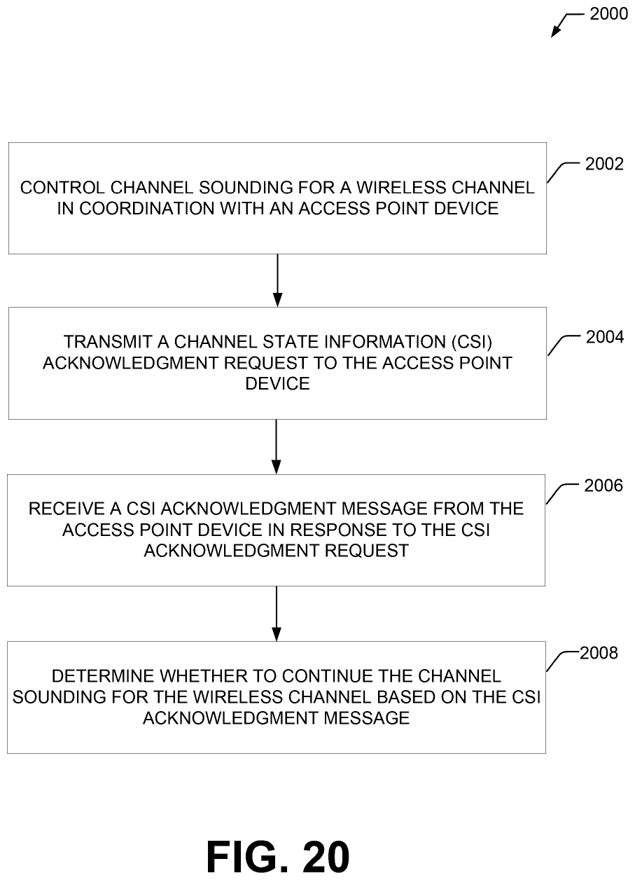

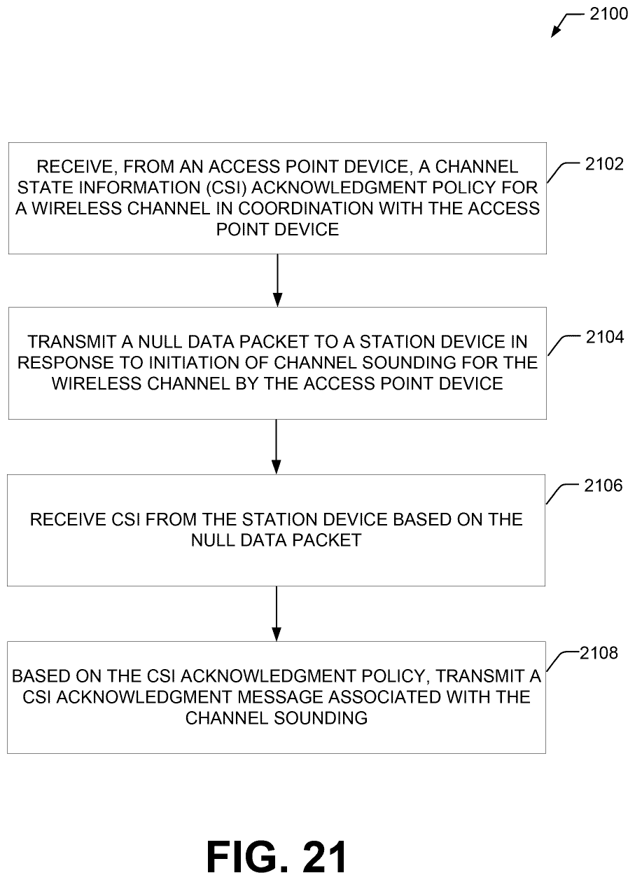

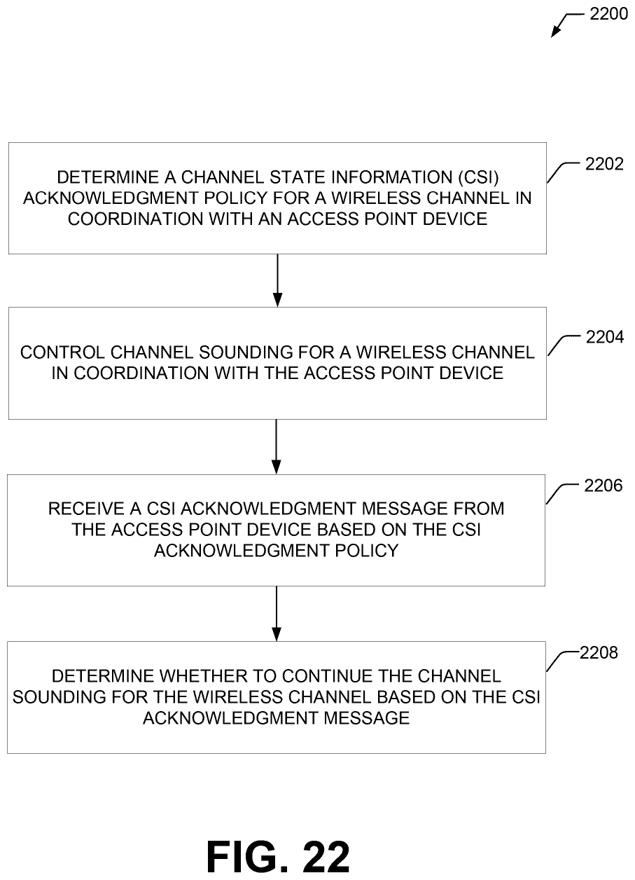

The apparatus 200 may be embodied by or otherwise associated with an access point. As another example, the apparatus is comprised in such an access point, e.g. as a chipset configured to control the access point. For example, the apparatus 200 embodied by or otherwise associated with an access point may be caused or configured to perform at least the method of FIG. 17, FIG. 18, FIG. 19, FIG. 20, FIG. 21, FIG. 22, and/or any one or more of the embodiments described.

The apparatus 200 may be embodied by or otherwise associated with a station, e.g., a user equipment or other client device. In another embodiment, the apparatus is comprised in such a station, e.g. as a chipset configured to control the station.

In an embodiment, at least some of the processes described herein may be carried out by an apparatus comprising means for carrying out at least some of the described processes. Means for performing method steps as disclosed herein may include software and/or hardware components of the apparatus 200. For example, the at least one processor 205, the memory 210, and instructions, such as for example the computer program code form means for carrying out the method or methods as disclosed herein, and any of the embodiments thereof. As used herein the term “means” is to be construed in singular form, e.g., referring to a single element, or in plural form, e.g., referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

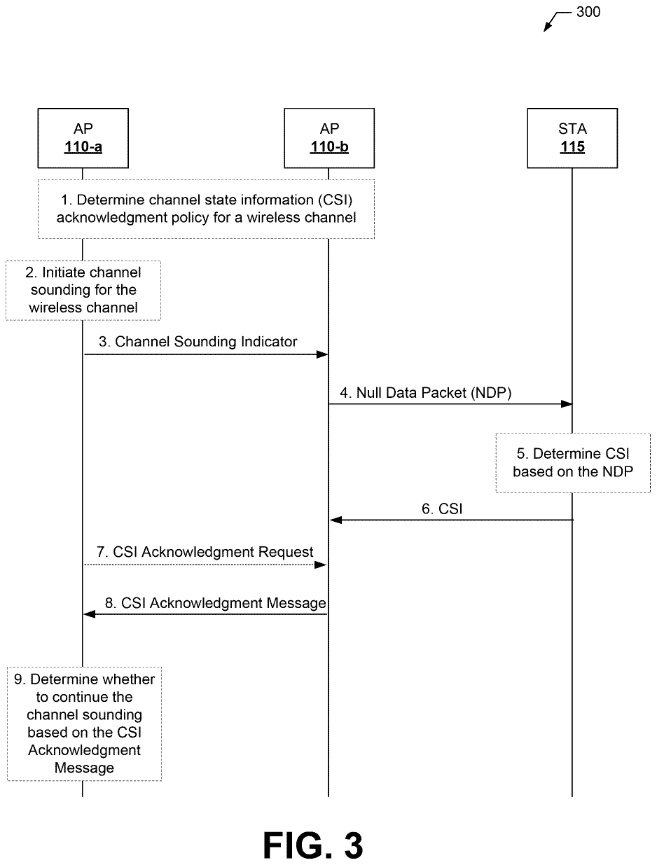

FIG. 3 illustrates example transmissions between AP 110-a, AP 110-b and STA 115 for enabling CSI acknowledgment in coordinated beamforming associated with a communication network (e.g., the communication network 105), according to one or more embodiments. The below example transmissions provide the foreseen steps, network signals, and/or messaging to enable the AP 110-b to transmit a CSI acknowledgment to the AP 110-a during channel sounding coordinated between the AP 110-a and the AP 110-b for a wireless channel of a communication network (e.g., the communication network 105). In some embodiments, the channel sounding may be provided for a WiFi communication network configured according to IEEE 802.11.

In some embodiments, the AP 110-a and the AP 110-b coordinate to determine a CSI acknowledgment policy for a wireless channel, at 1. For example, the AP 110-a and the AP 110-b may determine the CSI acknowledgment policy during or before initiation of coordinated beamforming between the AP 110-a and the AP 110-b. In some embodiments, the CSI acknowledgment policy may indicate criteria for sending a CSI acknowledgment by the AP 110-b. In some embodiments, the CSI acknowledgment policy may indicate that the AP 110-b is to transmit an CSI acknowledgment to the AP 110-a based on a determination that the CSI acknowledgment message corresponds to a positive CSI acknowledgment that indicates that the CSI is satisfies CSI quality criterion. For example, the CSI acknowledgment policy may be an “Only send positive acknowledgment” policy where a CSI acknowledgment is transmitted if CSI is received correctly. In some embodiments, the CSI acknowledgment policy may indicate that the AP 110-b is to transmit an CSI acknowledgment to the AP 110-a based on a determination that the CSI acknowledgment message corresponds to a negative CSI acknowledgment that indicates that the CSI does not satisfy CSI quality criterion. For example, the CSI acknowledgment policy may be an “Only send negative acknowledgment” policy where a CSI acknowledgment is transmitted if CSI is not received correctly.

In some embodiments, the CSI acknowledgment policy may indicate that the AP 110-b is to transmit an CSI acknowledgment to the AP 110-a in response to the CSI being received from the STA 115. For example, the CSI acknowledgment policy may be an “Immediate” policy where a CSI acknowledgment is transmitted immediately or substantially immediately after receiving CSI. In some embodiments, the CSI acknowledgment policy may indicate that the AP 110-b is to transmit an CSI acknowledgment to the AP 110-a in response to a CSI acknowledgment request provided by the access point device. For example, the CSI acknowledgment policy may be a “Delayed”-policy where a CSI acknowledgment is transmitted when explicitly requested. In some embodiments, the CSI acknowledgment policy may indicate that the AP 110-b is to transmit an CSI acknowledgment to the AP 110-a in response to the CSI being received from the STA 115 and other CSI being received from at least one other station device. For example, the CSI acknowledgment policy may be a “Cumulative” policy where a CSI acknowledgment is transmitted covering multiple CSI reports (e.g., after receiving CSI from multiple STAs). In some embodiments, the CSI acknowledgment policy may indicate that the AP 110-b is to transmit an CSI acknowledgment for a CSI report received from the STA 115. For example, the CSI acknowledgment policy may be a “Per-Link” policy where a CSI acknowledgment is separately transmitted for each CSI report received from different STAs.

In some embodiments, the CSI acknowledgment policy may indicate that the AP 110-b is to transmit an CSI acknowledgment to the AP 110-a based on a determination that the CSI satisfies a defined CSI quality threshold value. For example, the CSI acknowledgment policy may be a “Threshold-Based” policy where a CSI acknowledgment is transmitted if CSI meets a certain quality threshold (e.g., SNR, RSSI, error rate, etc.). In some embodiments, the CSI acknowledgment policy may indicate that the AP 110-b is to transmit an CSI acknowledgment to the AP 110-a in response to a certain number of CSI retransmissions. For example, the CSI acknowledgment policy may be a “Retry-Based” policy where a CSI acknowledgment is transmitted after a certain number of CSI retransmissions (e.g., adaptive acknowledgment). In some embodiments, the CSI acknowledgment policy may indicate that a CSI acknowledgment is to be associated with the STA 115 and one or more other station devices. For example, the CSI acknowledgment policy may be a “Group-Based” policy where a CSI acknowledgment is provided for multiple STAs in a single CSI ACK Response. In some embodiments, the CSI acknowledgment policy may indicate that the AP 110-b is to transmit an CSI acknowledgment to the AP 110-a based on a predefined rule regarding priority of the STA 115. For example, the CSI acknowledgment policy may be a “Prioritized” policy where a CSI acknowledgment is transmitted based on a priority mechanism (e.g., prioritize certain STAs or CSI reports based on predefined rules).

In some embodiments, the CSI acknowledgment policy may indicate that the AP 110-b is to transmit an CSI acknowledgment to the AP 110-a based on a predefined rule regarding respective subsets of the CSI. For example, the CSI acknowledgment policy may be a “Selective”-policy where a CSI acknowledgment includes certain parts of the CSI data (e.g., specific subcarriers, spatial streams, or frequency bands). In some embodiments, the CSI acknowledgment policy may indicate that the AP 110-b is to transmit an CSI acknowledgment to the AP 110-a in response to a determination that a certain interval of time has passed since the CSI is received from the STA 115. For example, the CSI acknowledgment policy may be a “Time-Sensitive” policy that specifies a maximum delay for sending a CSI acknowledgment message (e.g., “Send within X milliseconds after receiving CSI”, etc.). In some embodiments, the CSI acknowledgment policy may indicate that the AP 110-b is to transmit the CSI acknowledgment message to the AP 110-b based on a determination that a condition associated with the wireless channel is satisfied. For example, the CSI acknowledgment policy may be a “Conditional” policy where a CSI acknowledgment is transmitted if specific conditions are met (e.g., “ACK only if interference level is low”, etc.). As such, the CSI acknowledgment policy may be determined before a channel sounding procedure begins, for example, when two or more APs coordinate to perform CBF.

In some embodiments, the AP 110-a initiates channel sounding for the wireless channel, at 2. For example, the AP 110-a may generate and/or transmit an NDPA to initiate the channel sounding for the wireless channel. In some embodiments, the AP 110-b may receive the NDPA from the AP 110-a to determine the initiation of the channel sounding. Additionally, the AP 110-a may generate and/or transmit a BFRP to enable determination of CSI via the STA 115. In some embodiments, the AP 110-an may transmit the BFRP to the AP 110-b and/or the STA 115.

In some embodiments, the AP 110-a transmits a channel sounding indicator to the AP 110-b, at 3. For example, the AP 110-a may transmit the NDPA to the AP 110-b to indicate initiation of the channel sounding.

In some embodiments, the AP 110-b transmits a null data packet (NDP) to the STA 115, at 4. In some embodiments, the AP 110-b may transmit the NDP to the STA 115 in response to initiation of the channel sounding for the wireless channel by the AP 110-a. For example, the AP 110-b may transmit the NDP to the STA 115 in response to receiving the channel sounding indicator (e.g., the NDPA). In some embodiments, the NDP includes a set of training signals associated with a training sequence for channel measurement via the STA 115.

In some embodiments, the STA 115 determines CSI based on the NDP, at 5. For example, the STA 115 may measure characteristics of the wireless channel based on the data (e.g., the set of training signals) included in the NDP.

In some embodiments, the STA 115 transmits the CSI to the AP 110-b, at 6. For example, the AP 110-b may receive the CSI from the STA 115 based on the NDP.

In some embodiments, the AP 110-a transmits a CSI acknowledgment request to the AP 110-b, at 7. In some embodiments, the CSI acknowledgment request may activate a relevant CSI acknowledgment policy based on the predetermined agreement established at 1. In some embodiments, the CSI acknowledgment request includes an identifier (e.g., a station identifier) for the STA 115, an identifier (e.g., an access point identifier) for the AP 110-a, and/or an identifier (e.g., an access point identifier) for the AP 110-b. For example, the CSI acknowledgment message may include an identifier for a CSI link (e.g., “CSI from STA 115 to AP 110-b”). In some embodiments, the CSI acknowledgment request additionally or alternatively includes a session identifier for the channel sounding. For example, the session identifier may correlate the CSI acknowledgment request/response to a specific sounding procedure. In some embodiments, if the AP 110-a triggered multiple sequential/joint NDPA-NDP-BFRP exchanges, the session identifier may be utilized to indicate that the CSI acknowledgment request is about the cross-BSS CSI. In some embodiments, the CSI acknowledgment request additionally or alternatively includes information regarding a CSI acknowledgment policy determine at 1. In some embodiments, the AP 110-a may transmit, to the AP 110-b, a Block Acknowledgment Request (BAR) frame that comprises and/or corresponds to the CSI acknowledgment request. In some embodiments, the AP 110-a may transmit, to the AP 110-b, a null data packet announcement (NDPA) frame that comprises and/or corresponds to the CSI acknowledgment request. In some embodiments, the AP 110-a may transmit, to the AP 110-b, a beamforming report poll (BFRP) frame that comprises and/or corresponds to the CSI acknowledgment request. In some embodiments, the AP 110-a may transmit, to the AP 110-b, a management frame that comprises and/or corresponds to the CSI acknowledgment request. In some embodiments, the AP 110-a may transmit, to the AP 110-b, a control frame that comprises and/or corresponds to the CSI acknowledgment request. In some embodiments, the AP 110-a may transmit, to the AP 110-b, a data frame that comprises and/or corresponds to the CSI acknowledgment request.

In some embodiments, the AP 110-b transmits a CSI acknowledgment message to the AP 110-a, at 8. For example, the AP 110-a may transmit the CSI acknowledgment message to the AP 110-a based on the CSI received from the STA 115. In some embodiments, the AP 110-b may transmit the CSI acknowledgment request to the AP 110-a based on the CSI acknowledgment message provided by the AP 110-a. The AP 110-b may transmit the CSI acknowledgment message to the AP 110-a to enable continuation of the channel sounding by the AP 110-a. In some embodiments, the AP 110-b may additionally or alternatively transmit the CSI acknowledgment message to the STA 115 to enable continuation of the channel sounding by the AP 110-a.

In some embodiments, the CSI acknowledgment message includes an identifier (e.g., a station identifier) for the STA 115, an identifier (e.g., an access point identifier) for the AP 110-a, and/or an identifier (e.g., an access point identifier) for the AP 110-b. For example, the CSI acknowledgment message may include an identifier for a CSI link (e.g., “CSI from STA 115 to AP 110-b”). In some embodiments, the CSI acknowledgment message additionally or alternatively includes a status indicator regarding the CSI. For example, the status indicator may provide an indicator as to whether the AP 110-b successfully received the CSI (e.g., “Yes, CSI received” (success) or “No, CSI not received” (failure)). As an example, the status indicator may be a 1-byte “status code”: 0=success, 1=failure, 2=partial, etc. In some embodiments, the CSI acknowledgment message additionally or alternatively includes a session identifier for the channel sounding. For example, the session identifier may correlate the CSI acknowledgment request/response to a specific sounding procedure sent in the CSI acknowledgment request. In some embodiments, the CSI acknowledgment message additionally or alternatively includes information regarding a recommended next action for the AP 110-a. In some embodiments, the CSI acknowledgment message additionally or alternatively includes information regarding a recommended next action for the AP 110-a to enable the access point to (i) perform channel re-sounding associated with the wireless channel, (ii) withhold from performing channel re-sounding associated with the wireless channel, or (iii) forward the CSI to the AP 110-b. For example, the recommended next action may include a recommended action such as “Please re-sound now,” “Forward the CSI to me,” or “I'll do manual poll next time”, “no request for re-sound”, etc. In some embodiments, the CSI acknowledgment message additionally or alternatively includes information regarding a reason for failure associated with the CSI received from the STA 115. For example, if a failure for the CSI occurs, the information regarding a reason for failure may include a reason such as “channel too noisy,” “STA link was lost,” “interference detected” etc.

In some embodiments, the AP 110-b may transmit, to the AP 110-a, a block acknowledgment (BA) frame that comprises and/or corresponds to the CSI acknowledgment message. In some embodiments, the AP 110-b may transmit, to the AP 110-a, an NDPA frame that comprises and/or corresponds to the CSI acknowledgment message. In some embodiments, the AP 110-b may transmit, to the AP 110-a, an ACK frame that comprises and/or corresponds to the CSI acknowledgment message. In some embodiments, the AP 110-b may transmit, to the AP 110-a, a management frame that comprises and/or corresponds to the CSI acknowledgment message. In some embodiments, the AP 110-b may transmit, to the AP 110-a, a control frame that comprises and/or corresponds to the CSI acknowledgment message. In some embodiments, the AP 110-b may transmit, to the AP 110-a, a data frame that comprises and/or corresponds to the CSI acknowledgment message.

In some embodiments, the AP 110-b may transmit the CSI acknowledgment message to the AP 110-a based on a determination that the CSI acknowledgment message corresponds to a positive CSI acknowledgment that indicates that the CSI is satisfies CSI quality criterion. In some embodiments, the AP 110-b may transmit the CSI acknowledgment message to the AP 110-a based on a determination that the CSI acknowledgment message corresponds to a negative CSI acknowledgment that indicates that the CSI does not satisfy CSI quality criterion. In some embodiments, the AP 110-b may transmit the CSI acknowledgment message to the AP 110-a in response to the CSI being received from the STA 115. In some embodiments, the AP 110-b may transmit the CSI acknowledgment message to the AP 110-a in response to a CSI acknowledgment request provided by the access point device. In some embodiments, the AP 110-b may transmit the CSI acknowledgment message to the AP 110-a in response to the CSI being received from the STA 115 and other CSI being received from at least one other station device. In some embodiments, the AP 110-b may transmit the CSI acknowledgment message for a CSI report received from the STA 115. In some embodiments, the AP 110-b may transmit the CSI acknowledgment message to the AP 110-a based on a determination that the CSI satisfies a defined CSI quality threshold value. In some embodiments, the AP 110-b may transmit the CSI acknowledgment message to the AP 110-a in response to a certain number of CSI retransmissions. In some embodiments, the AP 110-b may transmit the CSI acknowledgment message to the AP 110-a based on a predefined rule regarding priority of the STA 115. In some embodiments, the AP 110-b may transmit the CSI acknowledgment message to the AP 110-a based on a predefined rule regarding respective subsets of the CSI. In some embodiments, the AP 110-b may transmit the CSI acknowledgment message to the AP 110-a in response to a determination that a certain interval of time has passed since the CSI is received from the STA 115. In some embodiments, the AP 110-b may transmit the CSI acknowledgment message to the AP 110-a based on a determination that a condition associated with the wireless channel is satisfied. In some embodiments, the CSI acknowledgment message may be associated with the STA 115 and one or more other station devices.

In some embodiments, the AP 110-a determines whether to continue the channel sounding based on the CSI acknowledgment message, at 9. For example, the AP 110-a may receive the CSI acknowledgment message from the AP 110-b to enable continuation of the channel sounding by the AP 110-a. In some embodiments, the AP 110-a may continue the channel sounding for the wireless channel based on a determination that the CSI acknowledgment message corresponds to a positive CSI acknowledgment. In some embodiments, the AP 110-a may receive the CSI acknowledgment message from the AP 110-b to end the channel sounding by the AP 110-a. In some embodiments, the AP 110-a may initiate resounding of the CSI based on a determination that the CSI acknowledgment message corresponds to a negative CSI acknowledgment. In some embodiments, the AP 110-a may transmit the CSI to the AP 110-b based on a determination that the CSI acknowledgment message corresponds to a negative CSI acknowledgment.

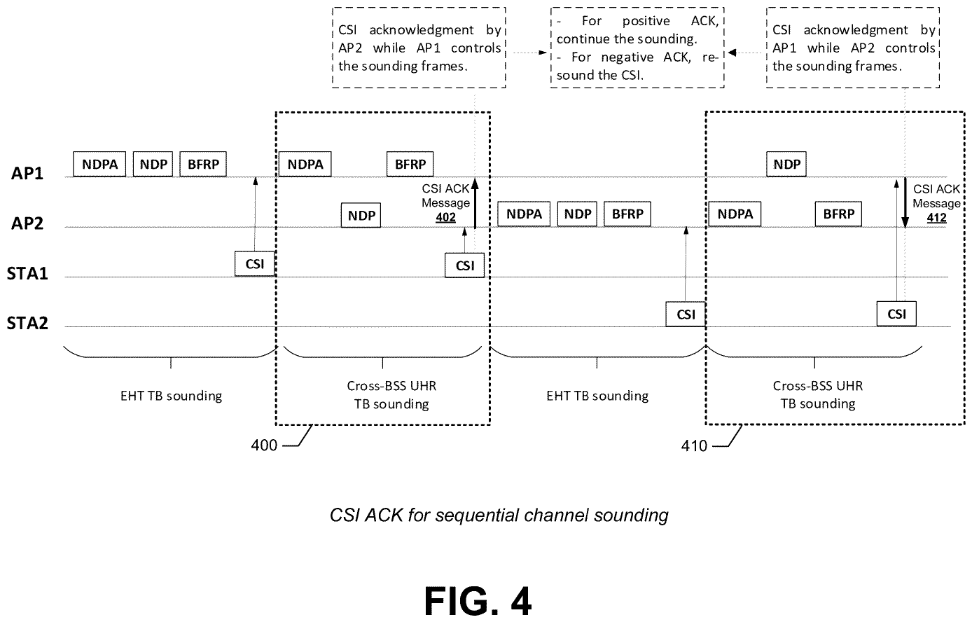

FIG. 4 illustrates example transmissions associated with APs and a STA for providing CSI acknowledgment associated with sequential channel sounding, according to one or more embodiments. In some embodiments, a channel sounding process 400 is performed by an AP1 (e.g., AP 110-a) and an AP2 (e.g., AP 110-b). The channel sounding process 400 may provide channel sounding for a wireless channel of a communication network (e.g., the communication network 105). For example, the AP1 may be a controlling AP for the channel sounding process 400 that sends NDPA and BFRP. Additionally, the AP2 may be a coordinating AP that receives CSI from STA1 triggered by the AP1 with the BFRP. In some embodiments, the channel sounding process 400 corresponds to Cross-BSS UHR TB sounding. In some embodiments, the AP1 initiates the channel sounding process 400 using the NDPA. Additionally, the AP2 may transmit an NDP to the STA1 to enable the STA1 to measure the wireless channel. The BFRP provided by the AP1 may indicate that the STA1 is to transmit the CSI to the AP2. Additionally, based a determination the CSI is successfully received by the AP2, the AP2 may transmit a CSI acknowledgment message (e.g., CSI ACK 402) to the AP1. If the CSI is positively acknowledged via the CSI ACK 402, the channel sounding process 400 may continue. However, if the CSI is negatively acknowledged via the CSI ACK 402, the AP1 may request re-sounding of the CSI from STA1 to AP2 on behalf of the AP2.

In some embodiments, a channel sounding process 410 is performed by an AP1 (e.g., AP 110-a) and an AP2 (e.g., AP 110-b). The channel sounding process 410 may provide channel sounding for a wireless channel of a communication network (e.g., the communication network 105). For example, the AP2 may be a controlling AP for the channel sounding process 410 that sends NDPA and BFRP. Additionally, the AP1 may be a coordinating AP that receives CSI from STA2 triggered by the AP2 with the BFRP. In some embodiments, the channel sounding process 410 corresponds to Cross-BSS UHR TB sounding. In some embodiments, the AP2 initiates the channel sounding process 410 using the NDPA. Additionally, the AP1 may transmit an NDP to the STA2 to enable the STA2 to measure the wireless channel. The BFRP provided by the AP2 may indicate that the STA2 is to transmit the CSI to the AP1. Additionally, based a determination the CSI is successfully received by the AP1, the AP1 may transmit a CSI acknowledgment message (e.g., CSI ACK 412) to the AP2. If the CSI is positively acknowledged via the CSI ACK 412, the channel sounding process 410 may continue. However, if the CSI is negatively acknowledged via the CSI ACK 412, the AP2 may request re-sounding of the CSI from STA2 to AP1 on behalf of the AP1.

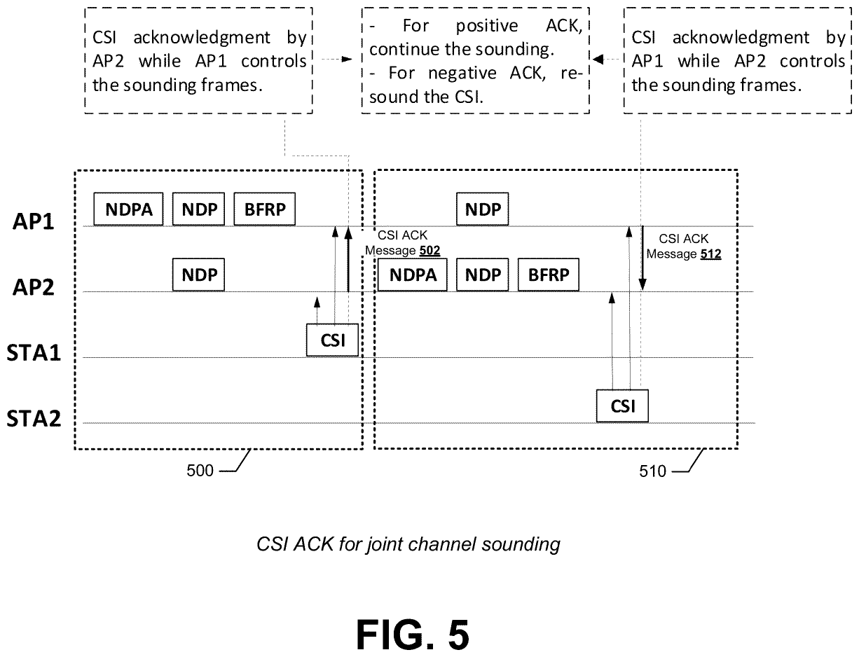

FIG. 5 illustrates example transmissions associated with APs and a STA for providing CSI acknowledgment associated with joint channel sounding, according to one or more embodiments. In some embodiments, a channel sounding process 500 is performed by an AP1 (e.g., AP 110-a) and an AP2 (e.g., AP 110-b). The channel sounding process 500 may provide channel sounding for a wireless channel of a communication network (e.g., the communication network 105). For example, the AP1 may be a controlling AP for the channel sounding process 400 that sends NDPA and BFRP. Additionally, the AP2 may be a coordinating AP that receives CSI from STA1 triggered by the AP1 with the BFRP. In some embodiments, the AP1 initiates the channel sounding process 500 using the NDPA. Additionally, the AP2 may transmit an NDP to the STA1 to enable the STA1 to measure the wireless channel. The BFRP provided by the AP1 may indicate that the STA1 is to transmit the CSI to the AP1 and the AP2. Additionally, based a determination the CSI is successfully received by the AP2, the AP2 may transmit a CSI acknowledgment message (e.g., CSI ACK 502) to the AP1. If the CSI is positively acknowledged via the CSI ACK 502, the channel sounding process 500 may continue. However, if the CSI is negatively acknowledged via the CSI ACK 502, the AP1 may request re-sounding of the CSI from STA1 to AP2 on behalf of the AP2.

In some embodiments, a channel sounding process 510 is performed by an AP1 (e.g., AP 110-a) and an AP2 (e.g., AP 110-b). The channel sounding process 510 may provide channel sounding for a wireless channel of a communication network (e.g., the communication network 105). For example, the AP2 may be a controlling AP for the channel sounding process 510 that sends NDPA and BFRP. Additionally, the AP1 may be a coordinating AP that receives CSI from STA2 triggered by the AP2 with the BFRP. In some embodiments, the AP2 initiates the channel sounding process 510 using the NDPA. Additionally, the AP1 may transmit an NDP to the STA2 to enable the STA2 to measure the wireless channel. The BFRP provided by the AP2 may indicate that the STA2 is to transmit the CSI to the AP1 and the AP2. Additionally, based a determination the CSI is successfully received by the AP1, the AP1 may transmit a CSI acknowledgment message (e.g., CSI ACK 512) to the AP2. If the CSI is positively acknowledged via the CSI ACK 512, the channel sounding process 510 may continue. However, if the CSI is negatively acknowledged via the CSI ACK 512, the AP2 may request re-sounding of the CSI from STA2 to AP1 on behalf of the AP1.

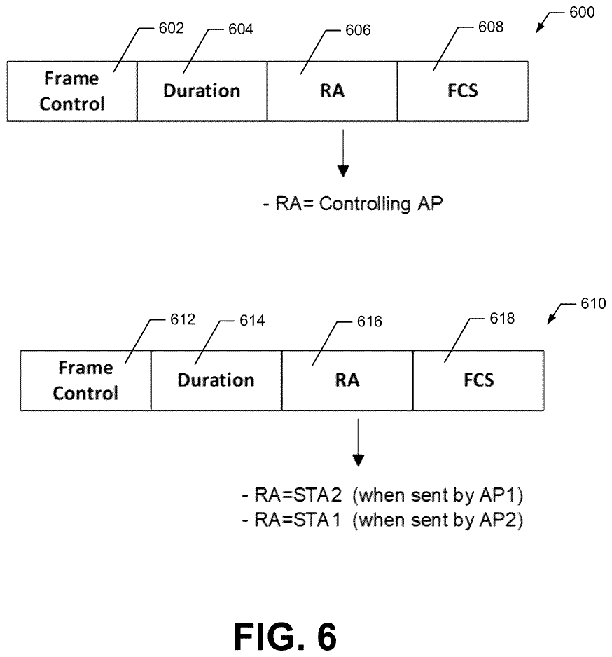

FIG. 6 illustrates an example format for a CSI acknowledgment message, according to one or more embodiments. For example, a CSI acknowledgment message 600 for sequential channel sounding and/or joint channel sounding may be an ACK frame that includes a frame control field 602, a duration field 604, a receiver address (RA) field 606, and a frame check sequence (FCS) field 608. In some embodiments, the CSI acknowledgment message 600 may serve as a CSI ACK response (e.g., a positive acknowledgment). In some embodiments, after a coordinating AP receives CSI in Cross-BSS UHR TB sounding or joint sounding, the coordinating AP may directly send the CSI acknowledgment message 600 to a controlling AP. For example, the CSI acknowledgment message 600 may be with the RA field 606 corresponding to AP2 (e.g., when AP1 transmits the CSI acknowledgment message 600) or the RA field 606 corresponding to AP1 (e.g., when AP2 transmits the CSI acknowledgment message 600). In some embodiments, the controlling AP may listen for the CSI acknowledgment message 600 from the coordinating AP immediately after transmitting the BFRP. This ensures that the controlling AP receives a CSI acknowledgment message from the coordinating AP, allowing the sounding procedure to continue (e.g., a positive acknowledgment). If the coordinating AP does not send the CSI acknowledgment message 600, it may indicate that the CSI was not received correctly (e.g., a negative acknowledgment), prompting the controlling AP to initiate re-sounding or the STA to re-send the CSI.

In another example, a CSI acknowledgment message 610 for sequential channel sounding and/or joint channel sounding may be an ACK frame that includes a frame control field 612, a duration field 614, an RA field 616, and an FCS field 618. In some embodiments, the CSI acknowledgment message 610 may serve as a CSI ACK response. In some embodiments, after a coordinating AP receives CSI in Cross-BSS UHR TB sounding or joint sounding, the coordinating AP may directly send the CSI acknowledgment message 610 to the STA it receives CSI from. For example, the CSI acknowledgment message 610 may include the RA field 616 equal to STA1 (e.g., when STA1 transmits CSI), the CSI acknowledgment message 610 may include the RA field 616 equal to STA2 (e.g., when STA2 transmits CSI). In this case, a controlling AP hears the CSI acknowledgment message 610. This ensures that the controlling AP receives CSI acknowledgment from the coordinating AP, allowing the sounding procedure to continue (e.g., a positive acknowledgment). If the coordinating AP does not send the CSI acknowledgment message 610, it may indicate that the CSI was not received correctly (e.g., a negative acknowledgment), prompting the controlling AP to initiate re-sounding or the STA to re-send the CSI.

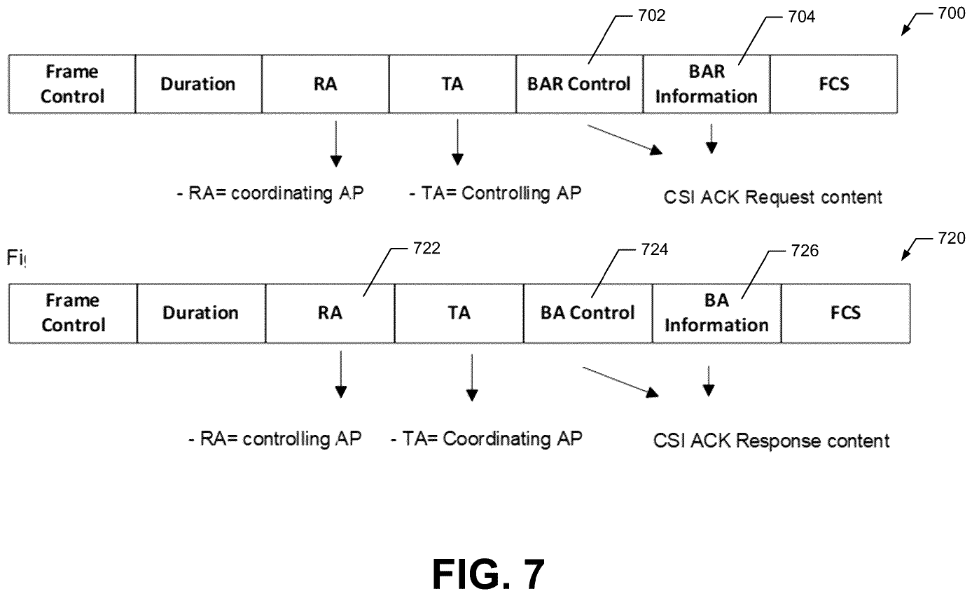

FIG. 7 illustrates an example format for a CSI acknowledgment request and a CSI acknowledgment message, according to one or more embodiments. For example, a CSI acknowledgment request 700 for sequential channel sounding and/or joint channel sounding may correspond to a block acknowledgment request (BAR) frame. Additionally or alternatively, a CSI acknowledgment message 720 for sequential channel sounding and/or joint channel sounding may correspond to a block acknowledgment (BA) frame. In some embodiments, a BAR control field 702 and/or a BAR information field 704 of the CSI acknowledgment request 700 may include content for a CSI ACK request. In some embodiments, a BA control field 724 and/or a BA information field 726 of the CSI acknowledgment message 720 may include content for a CSI ACK response. In some embodiments, after a coordinating AP receives CSI in Cross-BSS UHR TB sounding or joint sounding, the coordinating AP may send the CSI acknowledgment message 720 to a controlling AP. For example, the CSI acknowledgment message 720 may be configured as a BA with a RA field 722 equal to AP2 (e.g., when AP1 transmits the CSI acknowledgment message 720), or a BA with the RA field 722 equal to AP1 (e.g., when AP2 transmits the CSI acknowledgment message 720). The controlling AP may listen for the CSI acknowledgment message 720 from coordinating APs immediately after transmitting the BFRP. This ensures that the controlling AP receives a CSI acknowledgment message from the coordinating AP, allowing the sounding procedure to continue (e.g., a positive acknowledgment). If the coordinating AP does not send the CSI acknowledgment message 720, it may indicate that the CSI was not received correctly (e.g., a negative acknowledgment), prompting the controlling AP to initiate re-sounding or the STA to re-send the CSI. Alternatively, a coordinating AP may send the CSI acknowledgment message 720 to indicate that CSI was not received correctly (e.g., a negative acknowledgment). In some embodiments, a BA frame and/or a BAR frame may be transmitted, based on the CSI acknowledgment policy, after each sounding procedure (e.g., after a single NDPA/NDP+BFRP). In some embodiments, a BA frame and/or a BAR frame may be transmitted, based on the CSI acknowledgment policy, collectively after multiple sounding procedures (e.g., after multiple NDPA/NDP+BFRP transmissions). In some embodiments, a BA frame and/or a BAR frame may be transmitted, based on the CSI acknowledgment policy, independently outside of the sounding procedure.

In some embodiments, after the AP 110-b receives CSI in Cross-BSS UHR TB sounding or joint channel sounding, the AP 110-b may directly send a BA frame to the AP 110-a. For example, the BA may include a RA equal to AP 110-b (when AP 110-a transmits the BA). In some embodiments, the AP 110-a may listen for the BA from the AP 110-b immediately after transmitting the BFRP. This ensures that the AP 110-b receives the CSI acknowledgment message from the AP 110-b, allowing the sounding procedure to continue (e.g., a positive acknowledgment). If the AP 110-b does not send the BA frame, it may indicates that the CSI was not received correctly (e.g., a negative acknowledgment), which may prompt the AP 110-b to initiate re-sounding or the STA 115 to re-send the CSI. Alternatively, the AP 110-b may send the BA frame to indicate that CSI was not received correctly (e.g., a negative acknowledgment).

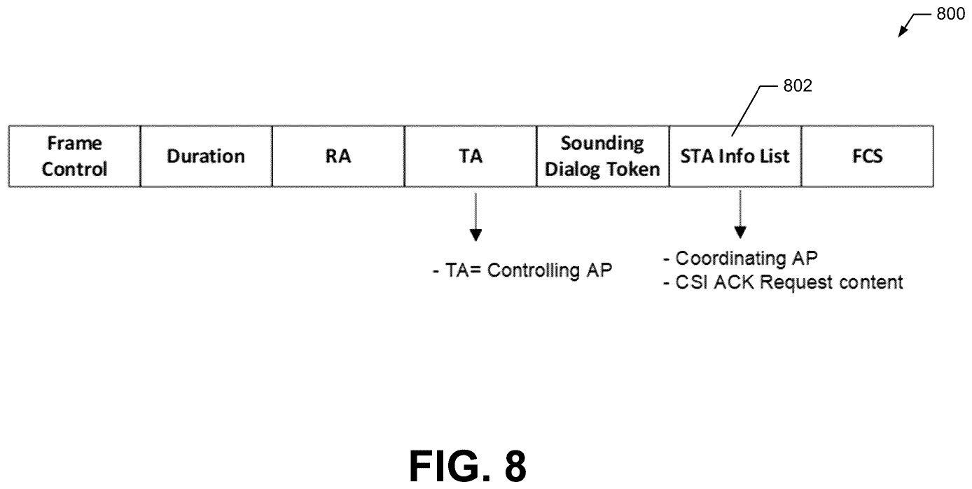

FIG. 8 illustrates an example format for a CSI acknowledgment request, according to one or more embodiments. For example, a CSI acknowledgment request 800 for sequential channel sounding and/or joint channel sounding may correspond to a NDPA frame. In some embodiments, an STA info list field 802 of the CSI acknowledgment request 800 may include information related to a coordinating AP and/or content related to a CSI ACK request. For example, the AP 110-a may utilize a NDPA frame or a CSI acknowledgment request in Cross-BSS UHR TB sounding or joint channel sounding. Additionally, the STA info list field 802 in NDPA may include a coordinating AP's identifier (e.g., to address coordinating AP) along with CSI ACK Request content. After receiving NDPA, the coordinating AP (e.g., the AP 110-b) may send a CSI acknowledgment message to the controlling AP (e.g., the AP 110-a). The CSI acknowledgment message may include positive acknowledgment or negative acknowledgment. Alternatively, the coordinating AP may send the CSI acknowledgment message to indicate that CSI was not received correctly (e.g., a negative acknowledgment).

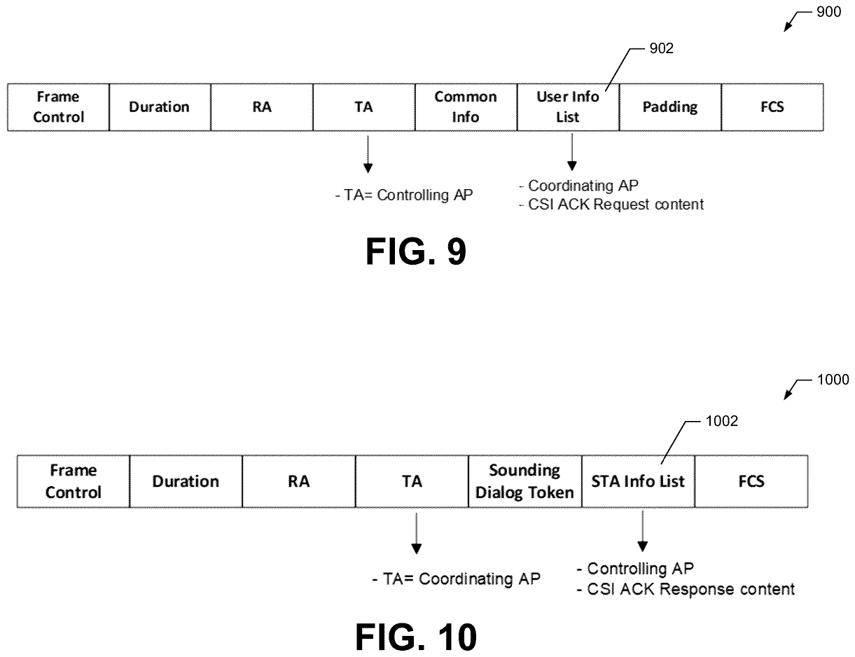

FIG. 9 illustrates an example format for a CSI acknowledgment request, according to one or more embodiments. For example, a CSI acknowledgment request 900 for sequential channel sounding and/or joint channel sounding may correspond to a BFRP frame. In some embodiments, a user info field 902 of the CSI acknowledgment request 900 may include information related to a coordinating AP and/or content related to a CSI ACK request. For example, the AP 110-a may utilize a BFRP frame or a CSI acknowledgment request in Cross-BSS UHR TB sounding or joint channel sounding. Additionally, the user info field 902 in BFRP may include a coordinating AP's identifier (e.g., to address coordinating AP) along with CSI ACK Request content. After receiving BFRP, the coordinating AP (e.g., the AP 110-b) may send a CSI acknowledgment message to the controlling AP (e.g., the AP 110-a). The controlling AP may listen for the CSI acknowledgment message from coordinating APs immediately after transmitting the BFRP. The CSI acknowledgment message may include positive acknowledgment or negative acknowledgment. Alternatively, the coordinating AP may send the CSI acknowledgment message to indicate that CSI was not received correctly (e.g., a negative acknowledgment).

FIG. 10 illustrates an example format for a CSI acknowledgment message, according to one or more embodiments. For example, a CSI acknowledgment message 1000 for sequential channel sounding and/or joint channel sounding may correspond to a NDPA frame. In some embodiments, an STA info list field 1002 of the CSI acknowledgment message 1000 may include information related to a coordinating AP and/or content related to a CSI ACK response. For example, the AP 110-a may utilize a NDPA frame for a previous Cross-BSS UHR TB sounding or joint channel sounding. Additionally, the STA info list field 802 in NDPA may include a coordinating AP's identifier (e.g., to address coordinating AP) along with CSI ACK Request content. The CSI acknowledgment message may include positive acknowledgment or negative acknowledgment. Alternatively, the coordinating AP may send the CSI acknowledgment message to indicate that CSI was not received correctly (e.g., a negative acknowledgment), prompting the controlling AP to initiate resounding.

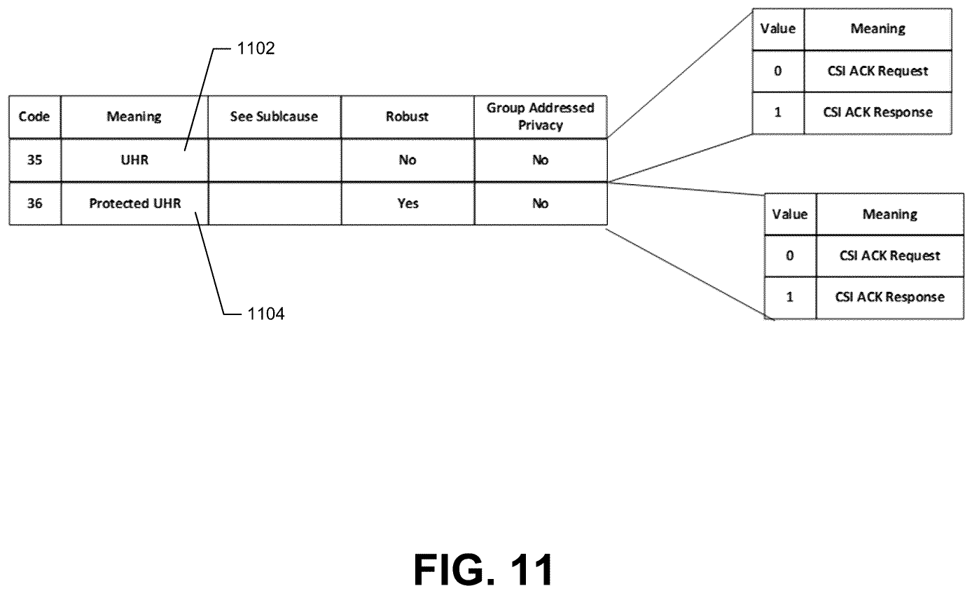

FIG. 11 illustrates an example format for a CSI acknowledgment request and a CSI acknowledgment message, according to one or more embodiments. For example, a UHR action frame 1102 for sequential channel sounding and/or joint channel sounding may correspond to a CSI acknowledgment request and/or a CSI acknowledgment message. Additionally, a protected UHR action frame 1104 for sequential channel sounding and/or joint channel sounding may correspond to a CSI acknowledgment request and/or a CSI acknowledgment message. For example, if code=40 is defined for UHR action frames, this category may include CSI ACK request (value 0) and CSI ACK response (value=1). As another example, if code=41 is defined for protected UHR action frames, this category may include CSI ACK request (value 0) and CSI ACK response (value=1).

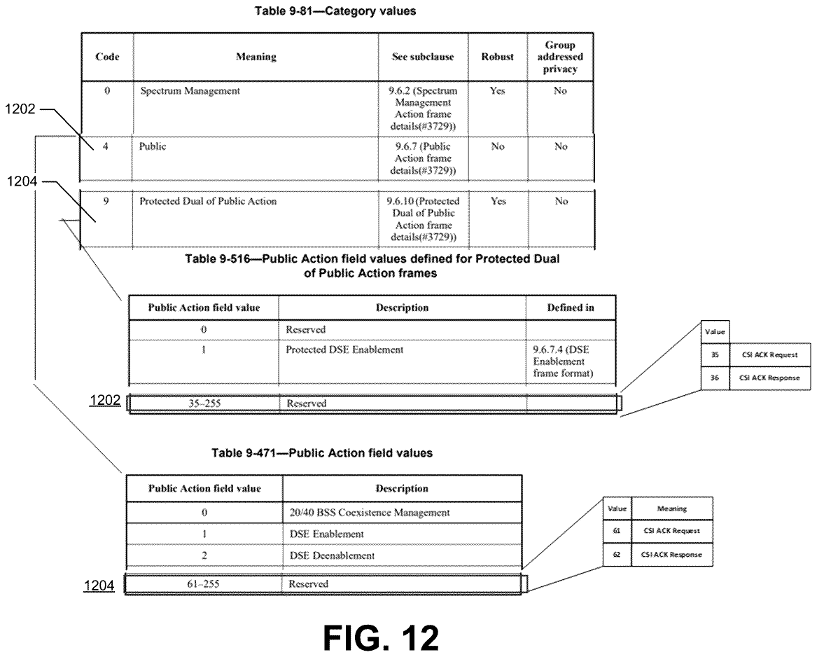

FIG. 12 illustrates an example format for a CSI acknowledgment request and a CSI acknowledgment message, according to one or more embodiments. For example, a public action frame 1202 for sequential channel sounding and/or joint channel sounding may correspond to a CSI acknowledgment request and/or a CSI acknowledgment message. Additionally, a protected dual of public action frame 1204 for sequential channel sounding and/or joint channel sounding may correspond to a CSI acknowledgment request and/or a CSI acknowledgment message. For example, Public Action (category=4) value=61 may be used for CSI ACK request and 62 can be used for CSI ACK response. As another example, Protected Dual of Public Action (category=9) value=35 may be used for CSI ACK request and 36 can be used for CSI ACK response.

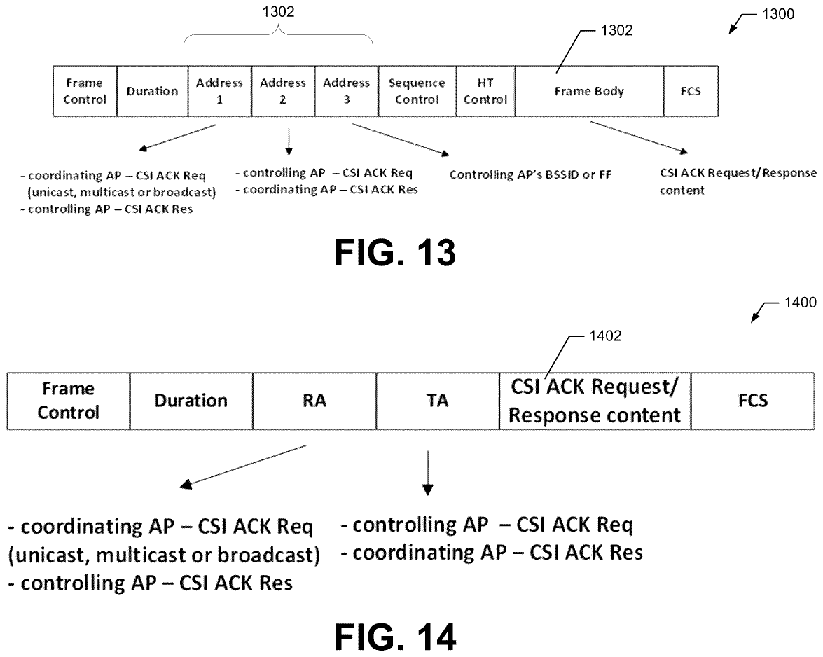

FIG. 13 illustrates an example format for a CSI acknowledgment request and a CSI acknowledgment message, according to one or more embodiments. For example, a management frame 1300 for sequential channel sounding and/or joint channel sounding may correspond to a CSI acknowledgment request and/or a CSI acknowledgment message. In some embodiments, one or more address fields 1302 of the management frame 1300 may include information related to a controlling AP and/or a coordinating AP. In some embodiments, a frame body field 1302 of the management frame 1300 may include content related to a CSI acknowledgment request and/or a CSI acknowledgment message. In some embodiments, for CSI ACK request, if there is one controlling AP and one coordinating AP (unicast), since the transmitter is controlling AP, Address1 (Receive Address) is coordinating AP's MAC and Address 2 (Transmitter Address) is controlling AP's MAC. Address 3 can be controlling AP's MAC or FF. If there is one controlling AP and more than one coordinating AP (multicast/broadcast), since the transmitter is controlling AP, Address1 (Receive Address) is broadcast or multicast address (so that multiple coordinating APs receive it), and Address 2 (Transmitter Address) is controlling AP's MAC. Address 3 can be controlling AP's MAC or FF. In some embodiments, for CSI ACK response, since the transmitter is single coordinating AP, Address1 (Receive Address) is controlling AP's MAC and Address 2 (Transmitter Address) is coordinating AP's MAC. Address 3 can be controlling AP's MAC or FF. Note that in this case, the frame body includes CSI ACK Response content.

FIG. 14 illustrates an example format for a CSI acknowledgment request and a CSI acknowledgment message, according to one or more embodiments. For example, a control frame 1400 for sequential channel sounding and/or joint channel sounding may correspond to a CSI acknowledgment request and/or a CSI acknowledgment message. In some embodiments, a field 1402 of the control frame 1400 may include information related to a coordinating AP and/or content related to a CSI ACK response. In some embodiments, for CSI ACK request, if there is one controlling AP and one coordinating AP (unicast), since the transmitter is controlling AP, RA is coordinating AP's MAC and TA is controlling AP's MAC. If there is one controlling AP and more than one coordinating AP (multicast/broadcast), since the transmitter is controlling AP, RA is broadcast or multicast address (so that multiple coordinating APs receive it), and TA is controlling AP's MAC. In some embodiments, for CSI ACK response, since the transmitter is single coordinating AP, RA is controlling AP's MAC and TA is coordinating AP's MAC. Note that in this case, the frame header includes CSI ACK Response content

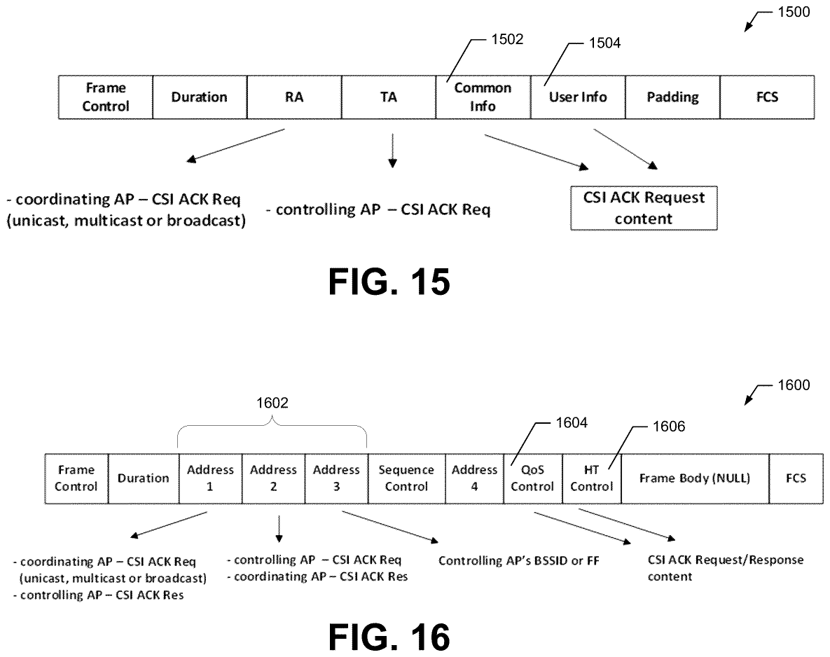

FIG. 15 illustrates an example format for a CSI acknowledgment request and a CSI acknowledgment message, according to one or more embodiments. For example, a trigger frame 1500 for sequential channel sounding and/or joint channel sounding may correspond to a CSI acknowledgment request and/or a CSI acknowledgment message. In some embodiments, a common info field 1502 and/or a user info field 1504 of the trigger frame 1500 may include information related to a coordinating AP and/or content related to a CSI ACK response. In some embodiments, the trigger frame 1500 is a type of control frame. In some embodiments, for CSI ACK request, if there is one controlling AP and one coordinating AP (unicast), since the transmitter is controlling AP, RA is coordinating AP's MAC and TA is controlling AP's MAC.

FIG. 16 illustrates an example format for a CSI acknowledgment request and a CSI acknowledgment message, according to one or more embodiments. For example, a data frame 1600 for sequential channel sounding and/or joint channel sounding may correspond to a CSI acknowledgment request and/or a CSI acknowledgment message. In some embodiments, one or more address fields 1602 of the data frame 1600 may include information related to a controlling AP and/or a coordinating AP. In some embodiments, a QoS control field 1604 and/or an HT control field 1606 of the data frame 1600 may include information related to a coordinating AP and/or content related to a CSI ACK response. In some embodiments, the data frame 1600 is a data frame with no frame body. In some embodiments, the data frame 1600 is a QoS Null Data frame. In some embodiments, for CSI ACK request, if there is one controlling AP and one coordinating AP (unicast), since the transmitter is controlling AP, Address1 (Receive Address) is coordinating AP's MAC and Address 2 (Transmitter Address) is controlling AP's MAC. Address 3 can be controlling AP's MAC or FF. If there is one controlling AP and more than one coordinating AP (multicast/broadcast), since the transmitter is controlling AP, Address1 (Receive Address) is broadcast or multicast address (so that multiple coordinating APs receive it), and Address 2 (Transmitter Address) is controlling AP's MAC. Address 3 can be controlling AP's MAC or FF. In some embodiments, for CSI ACK response, since the transmitter is single coordinating AP, Address1 (Receive Address) is controlling AP's MAC and Address 2 (Transmitter Address) is coordinating AP's MAC. Address 3 can be controlling AP's MAC or FF. In some embodiments, the QoS Control or HT control field includes CSI ACK Request content.

FIG. 17 illustrates a flowchart depicting a method 1700, FIG. 18 illustrates a flowchart depicting a method 1800, FIG. 19 illustrates a flowchart depicting a method 1900, FIG. 20 illustrates a flowchart depicting a method 2000, FIG. 21 illustrates a flowchart depicting a method 2100, and FIG. 22 illustrates a flowchart depicting a method 2200 according to one or more example embodiments of the present disclosure. It will be understood that each block of the flowcharts and combination of blocks in the flowcharts can be implemented by various means, such as hardware, firmware, processor, circuitry, and/or other communication devices associated with execution of software including instructions, for example one or more computer program instructions. For example, one or more of the procedures described above can be embodied by computer program instructions. In this regard, the computer program instructions which embody the procedures described above can be stored, for example, by the memory 210 of the apparatus 200 employing an embodiment of the present disclosure and executed by the processor 205. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Referring now to FIG. 17, the operations performed, such as by the apparatus 200 of FIG. 2, in order to enable CSI acknowledgment in coordinated beamforming of a communication network, in accordance with one or more embodiments of the present disclosure. In some embodiments, the method 1700 is associated with functionality of an AP (e.g., AP 110-b). As shown in block 1702 of FIG. 17, the apparatus 200 includes means, such as the processor 205, the memory 210, or the like, configured to transmit a null data packet to a station device in response to initiation of channel sounding for a wireless channel by an access point device.

As shown in block 1704 of FIG. 17, the apparatus 200 additionally or alternatively includes means, such as the processor 205, the memory 210, or the like, configured to receive channel state information (CSI) from the station device based on the null data packet.

As shown in block 1706 of FIG. 17, the apparatus 200 additionally or alternatively includes means, such as the processor 205, the memory 210, or the like, configured to, based on the CSI received from the station device, transmit a CSI acknowledgment message associated with the channel sounding.

In some embodiments, transmitting the CSI acknowledgment message comprises transmitting the CSI acknowledgment message to the access point device to enable continuation of the channel sounding by the access point device. In some embodiments, transmitting the CSI acknowledgment message comprises transmitting the CSI acknowledgment message to the access point device to initiate re-sounding associated with the CSI. In some embodiments, transmitting the CSI acknowledgment message comprises transmitting the CSI acknowledgment message to the access point device to provide a recommend next action for the access point device.

In some embodiments, transmitting the CSI acknowledgment message comprises transmitting the CSI acknowledgment message to the station device to enable continuation of the channel sounding by the access point device. In some embodiments, transmitting the CSI acknowledgment message comprises transmitting the CSI acknowledgment message to the station device to initiate re-sounding associated with the CSI. In some embodiments, transmitting the CSI acknowledgment message comprises transmitting the CSI acknowledgment message to the station device to provide a recommend next action for the access point device.

In some embodiments, the CSI acknowledgment message comprises a station identifier for the station device, an identifier for the apparatus 200 (e.g., an access point device) associated with the method 1700, and/or an access point identifier for the access point device. In some embodiments, the CSI acknowledgment message comprises a status indicator regarding the CSI. In some embodiments, the status indicator corresponds to a positive CSI status, a negative CSI status, a partially positive CSI status, or a partially negative CSI status. In some embodiments, the CSI acknowledgment message comprises a session identifier for the channel sounding. In some embodiments, the CSI acknowledgment message comprises information regarding a recommended next action for the access point device to enable the access point to (i) perform channel re-sounding associated with the wireless channel, (ii) withhold from performing channel re-sounding associated with the wireless channel, or (iii) forward the CSI to the apparatus. In some embodiments, the CSI acknowledgment message comprises information regarding a reason for failure associated with the CSI received from the station device.

In some embodiments, transmitting the CSI acknowledgment message comprises transmitting the CSI acknowledgment message in response to a CSI acknowledgment request provided by the access point device. In some embodiments, the CSI acknowledgment request comprises a station identifier for the station device, an identifier for the apparatus 200 (e.g., an access point device) associated with the method 1700, and/or an access point identifier for the access point device. In some embodiments, the CSI acknowledgment request comprises a session identifier for the channel sounding. In some embodiments, the CSI acknowledgment request comprises a CSI acknowledgment policy for the channel sounding.

In some embodiments, the apparatus 200 additionally or alternatively includes means, such as the processor 205, the memory 210, or the like, configured to transmit the CSI acknowledgment message to the access point device (i) in response to receiving the CSI from the station device, (ii) in response to completion of the channel sounding, or (iii) during a network process that is different than the channel sounding.

In some embodiments, a null data packet announcement (NDPA) frame, an acknowledgment frame, a Block Acknowledgement (BA) frame, a management frame, a control frame, or a data frame comprises the CSI acknowledgement message.

In some embodiments, the apparatus 200 additionally or alternatively includes means, such as the processor 205, the memory 210, or the like, configured to receive the CSI acknowledgment request from the access point device (i) in response to receiving the CSI from the station device, (ii) in response to completion of the channel sounding, or (iii) during a network process that is different than the channel sounding.

Referring now to FIG. 18, the operations performed, such as by the apparatus 200 of FIG. 2, in order to enable CSI acknowledgment in coordinated beamforming of a communication network, in accordance with one or more embodiments of the present disclosure. In some embodiments, the method 1800 is associated with functionality of an AP (e.g., AP 110-a). As shown in block 1802 of FIG. 18, the apparatus 200 includes means, such as the processor 205, the memory 210, or the like, configured to control channel sounding for a wireless channel in coordination with an access point device.

As shown in block 1804 of FIG. 18, the apparatus 200 additionally or alternatively includes means, such as the processor 205, the memory 210, or the like, configured to receive a channel state information (CSI) acknowledgment message from the access point device.

As shown in block 1806 of FIG. 18, the apparatus 200 additionally or alternatively includes means, such as the processor 205, the memory 210, or the like, configured to determine whether to continue the channel sounding for the wireless channel based on the CSI acknowledgment message.

In some embodiments, the apparatus 200 additionally or alternatively includes means, such as the processor 205, the memory 210, or the like, configured to continue the channel sounding for the wireless channel based on a determination that the CSI acknowledgment message corresponds to a positive CSI acknowledgment.

In some embodiments, the apparatus 200 additionally or alternatively includes means, such as the processor 205, the memory 210, or the like, configured to initiate resounding of the CSI based on a determination that the CSI acknowledgment message corresponds to a negative CSI acknowledgment.

In some embodiments, the apparatus 200 additionally or alternatively includes means, such as the processor 205, the memory 210, or the like, configured to transmit the CSI to the access point device based on a determination that the CSI acknowledgment message corresponds to a negative CSI acknowledgment.

In some embodiments, the CSI acknowledgment message comprises a station identifier for the station device, an identifier for the apparatus 200 (e.g., an access point device) associated with the method 1800, and/or an access point identifier for the access point device. In some embodiments, the CSI acknowledgment message comprises a status indicator regarding the CSI. In some embodiments, the status indicator corresponds to a positive CSI status, a negative CSI status, a partially positive CSI status, or a partially negative CSI status. In some embodiments, the CSI acknowledgment message comprises a session identifier for the channel sounding.

In some embodiments, the apparatus 200 additionally or alternatively includes means, such as the processor 205, the memory 210, or the like, configured to transmit a CSI acknowledgment request to the access point device to request the CSI acknowledgment message. In some embodiments, the CSI acknowledgment request comprises a station identifier for the station device, an identifier for the apparatus 200 (e.g., an access point device) associated with the method 1800, and/or an access point identifier for the access point device. In some embodiments, the CSI acknowledgment request comprises a session identifier for the channel sounding. In some embodiments, the CSI acknowledgment request comprises a CSI acknowledgment policy for the channel sounding.

In some embodiments, the apparatus 200 additionally or alternatively includes means, such as the processor 205, the memory 210, or the like, configured to perform a next action based on a recommendation included in the CSI acknowledgment message.

In some embodiments, the apparatus 200 additionally or alternatively includes means, such as the processor 205, the memory 210, or the like, configured to receive the CSI acknowledgment message from the access point device (i) in response to the access point device receiving the CSI from the station device, (ii) in response to completion of the channel sounding, or (iii) during a network process that is different than the channel sounding.

In some embodiments, a null data packet announcement (NDPA) frame, an acknowledgment frame, a Block Acknowledgement (BA) frame, a management frame, a control frame, or a data frame comprises the CSI acknowledgement message.

In some embodiments, the CSI acknowledgment request comprises a CSI acknowledgment policy for the channel sounding. In some embodiments, the CSI acknowledgment policy indicates criteria for transmission of the CSI acknowledgment message.

In some embodiments, the apparatus 200 additionally or alternatively includes means, such as the processor 205, the memory 210, or the like, configured to transmit the CSI acknowledgment request to the access point device (i) in response to the access point device receiving the CSI from the station device, (ii) in response to completion of the channel sounding, or (iii) during a network process that is different than the channel sounding.

Referring now to FIG. 19, the operations performed, such as by the apparatus 200 of FIG. 2, in order to enable CSI acknowledgment in coordinated beamforming of a communication network, in accordance with one or more embodiments of the present disclosure. In some embodiments, the method 1900 is associated with functionality of an AP (e.g., AP 110-b). As shown in block 1902 of FIG. 19, the apparatus 200 includes means, such as the processor 205, the memory 210, or the like, configured to transmit a null data packet to a station device in response to initiation of channel sounding for a wireless channel by an access point device.

As shown in block 1904 of FIG. 19, the apparatus 200 additionally or alternatively includes means, such as the processor 205, the memory 210, or the like, configured to receive channel state information (CSI) from the station device based on the null data packet.

As shown in block 1906 of FIG. 19, the apparatus 200 additionally or alternatively includes means, such as the processor 205, the memory 210, or the like, configured to receive a CSI acknowledgment request from the access point device.

As shown in block 1908 of FIG. 19, the apparatus 200 additionally or alternatively includes means, such as the processor 205, the memory 210, or the like, configured to, based on the CSI acknowledgment request, transmit a CSI acknowledgment message associated with the channel sounding.

In some embodiments, transmitting the CSI acknowledgment message comprises transmitting the CSI acknowledgment message to the access point device to enable continuation of the channel sounding by the access point device.

In some embodiments, transmitting the CSI acknowledgment message comprises transmitting the CSI acknowledgment message to the station device to enable continuation of the channel sounding by the access point device. In some embodiments, transmitting the CSI acknowledgment message comprises transmitting the CSI acknowledgment message to the station device to initiate re-sounding associated with the CSI. In some embodiments, transmitting the CSI acknowledgment message comprises transmitting the CSI acknowledgment message to the station device to provide a recommend next action for the access point device.

In some embodiments, the CSI acknowledgment message comprises a station identifier for the station device, an identifier for the apparatus 200 (e.g., an access point device) associated with the method 1900, and/or an access point identifier for the access point device. In some embodiments, the CSI acknowledgment message comprises a status indicator regarding the CSI. In some embodiments, the status indicator corresponds to a positive CSI status, a negative CSI status, a partially positive CSI status, or a partially negative CSI status. In some embodiments, the CSI acknowledgment message comprises a session identifier for the channel sounding. In some embodiments, the CSI acknowledgment message comprises information regarding a recommended next action for the access point device to enable the access point to (i) perform channel re-sounding associated with the wireless channel, (ii) withhold from performing channel re-sounding associated with the wireless channel, or (iii) forward the CSI to the apparatus. In some embodiments, the CSI acknowledgment message comprises information regarding a reason for failure associated with the CSI received from the station device.

In some embodiments, the CSI acknowledgment request comprises a station identifier for the station device, an identifier for the apparatus 200 (e.g., an access point device) associated with the method 1900, and/or an access point identifier for the access point device. In some embodiments, the CSI acknowledgment request comprises a session identifier for the channel sounding. In some embodiments, the CSI acknowledgment request comprises a CSI acknowledgment policy for the channel sounding. In some embodiments, a Block Acknowledgment Request (BAR) frame, a null data packet announcement (NDPA) frame, or a beamforming report poll (BFRP) frame, a management frame, a control frame, or a data frame comprises the CSI acknowledgment request.

In some embodiments, the apparatus 200 additionally or alternatively includes means, such as the processor 205, the memory 210, or the like, configured to transmit the CSI acknowledgment message to the access point device (i) in response to receiving the CSI from the station device, (ii) in response to completion of the channel sounding, or (iii) during a network process that is different than the channel sounding.

In some embodiments, a null data packet announcement (NDPA) frame, an acknowledgment frame, a Block Acknowledgement (BA) frame, a management frame, a control frame, or a data frame comprises the CSI acknowledgement message.

In some embodiments, the apparatus 200 additionally or alternatively includes means, such as the processor 205, the memory 210, or the like, configured to receive the CSI acknowledgment request from the access point device (i) in response to receiving the CSI from the station device, (ii) in response to completion of the channel sounding, or (iii) during a network process that is different than the channel sounding.

Referring now to FIG. 20, the operations performed, such as by the apparatus 200 of FIG. 2, in order to enable CSI acknowledgment in coordinated beamforming of a communication network, in accordance with one or more embodiments of the present disclosure. In some embodiments, the method 2000 is associated with functionality of an AP (e.g., AP 110-a). As shown in block 2002 of FIG. 20, the apparatus 200 includes means, such as the processor 205, the memory 210, or the like, configured to control channel sounding for a wireless channel in coordination with an access point device.

As shown in block 2004 of FIG. 20, the apparatus 200 additionally or alternatively includes means, such as the processor 205, the memory 210, or the like, configured to transmit a channel state information (CSI) acknowledgment request to the access point device.

As shown in block 2006 of FIG. 20, the apparatus 200 additionally or alternatively includes means, such as the processor 205, the memory 210, or the like, configured to receive a CSI acknowledgment message from the access point device in response to the CSI acknowledgment request.

As shown in block 2008 of FIG. 20, the apparatus 200 additionally or alternatively includes means, such as the processor 205, the memory 210, or the like, configured to determine whether to continue the channel sounding for the wireless channel based on the CSI acknowledgment message.

In some embodiments, the apparatus 200 additionally or alternatively includes means, such as the processor 205, the memory 210, or the like, configured to continue the channel sounding for the wireless channel based on a determination that the CSI acknowledgment message corresponds to a positive CSI acknowledgment.

In some embodiments, the apparatus 200 additionally or alternatively includes means, such as the processor 205, the memory 210, or the like, configured to initiate resounding of the CSI based on a determination that the CSI acknowledgment message corresponds to a negative CSI acknowledgment.

In some embodiments, the apparatus 200 additionally or alternatively includes means, such as the processor 205, the memory 210, or the like, configured to transmit the CSI to the access point device based on a determination that the CSI acknowledgment message corresponds to a negative CSI acknowledgment.

In some embodiments, the CSI acknowledgment message comprises a station identifier for the station device, an identifier for the apparatus 200 (e.g., an access point device) associated with the method 2000, and/or an access point identifier for the access point device. In some embodiments, the CSI acknowledgment message comprises a status indicator regarding the CSI. In some embodiments, the status indicator corresponds to a positive CSI status, a negative CSI status, a partially positive CSI status, or a partially negative CSI status. In some embodiments, the CSI acknowledgment message comprises a session identifier for the channel sounding.

In some embodiments, the CSI acknowledgment request comprises a station identifier for the station device, an identifier for the apparatus 200 (e.g., an access point device) associated with the method 2000, and/or an access point identifier for the access point device. In some embodiments, the CSI acknowledgment request comprises a session identifier for the channel sounding. In some embodiments, the CSI acknowledgment request comprises a CSI acknowledgment policy for the channel sounding. In some embodiments, a Block Acknowledgment Request (BAR) frame, a null data packet announcement (NDPA) frame, or a beamforming report poll (BFRP) frame, a management frame, a control frame, or a data frame comprises the CSI acknowledgment request.

In some embodiments, the CSI acknowledgment request comprises a CSI acknowledgment policy for the channel sounding. In some embodiments, the CSI acknowledgment policy indicates criteria for transmission of the CSI acknowledgment message.

In some embodiments, the apparatus 200 additionally or alternatively includes means, such as the processor 205, the memory 210, or the like, configured to transmit the CSI acknowledgment request to the access point device (i) in response to the access point device receiving the CSI from the station device, (ii) in response to completion of the channel sounding, or (iii) during a network process that is different than the channel sounding.

Referring now to FIG. 21, the operations performed, such as by the apparatus 200 of FIG. 2, in order to enable CSI acknowledgment in coordinated beamforming of a communication network, in accordance with one or more embodiments of the present disclosure. In some embodiments, the method 2100 is associated with functionality of an AP (e.g., AP 110-b). As shown in block 2102 of FIG. 21, the apparatus 200 includes means, such as the processor 205, the memory 210, or the like, configured to receive, from an access point device, a channel state information (CSI) acknowledgment policy for a wireless channel in coordination with the access point device.

In some embodiments, the apparatus 200 additionally or alternatively includes means, such as the processor 205, the memory 210, or the like, configured to perform a next action based on a recommendation included in the CSI acknowledgment message.

In some embodiments, the apparatus 200 additionally or alternatively includes means, such as the processor 205, the memory 210, or the like, configured to receive the CSI acknowledgment message from the access point device (i) in response to the access point device receiving the CSI from the station device, (ii) in response to completion of the channel sounding, or (iii) during a network process that is different than the channel sounding.

In some embodiments, a null data packet announcement (NDPA) frame, an acknowledgment frame, a Block Acknowledgement (BA) frame, a management frame, a control frame, or a data frame comprises the CSI acknowledgement message.

As shown in block 2104 of FIG. 21, the apparatus 200 additionally or alternatively includes means, such as the processor 205, the memory 210, or the like, configured to transmit a null data packet to a station device in response to initiation of channel sounding for the wireless channel by the access point device.

As shown in block 2106 of FIG. 21, the apparatus 200 additionally or alternatively includes means, such as the processor 205, the memory 210, or the like, configured to receive CSI from the station device based on the null data packet.

As shown in block 2108 of FIG. 21, the apparatus 200 additionally or alternatively includes means, such as the processor 205, the memory 210, or the like, configured to, based on the CSI acknowledgment policy, transmit a CSI acknowledgment message associated with the channel sounding.

In some embodiments, transmitting the CSI acknowledgment message comprises transmitting the CSI acknowledgment message to the access point device to enable continuation of the channel sounding by the access point device. In some embodiments, transmitting the CSI acknowledgment message comprises transmitting the CSI acknowledgment message to the access point device to initiate re-sounding associated with the CSI. In some embodiments, transmitting the CSI acknowledgment message comprises transmitting the CSI acknowledgment message to the access point device to provide a recommend next action for the access point device.

In some embodiments, transmitting the CSI acknowledgment message comprises transmitting the CSI acknowledgment message to the station device to enable continuation of the channel sounding by the access point device. In some embodiments, transmitting the CSI acknowledgment message comprises transmitting the CSI acknowledgment message to the station device to initiate re-sounding associated with the CSI. In some embodiments, transmitting the CSI acknowledgment message comprises transmitting the CSI acknowledgment message to the station device to provide a recommend next action for the access point device.

In some embodiments, the CSI acknowledgment message comprises a station identifier for the station device, an identifier for the apparatus 200 (e.g., an access point device) associated with the method 2100, and/or an access point identifier for the access point device. In some embodiments, the CSI acknowledgment message comprises a status indicator regarding the CSI. In some embodiments, the status indicator corresponds to a positive CSI status, a negative CSI status, a partially positive CSI status, or a partially negative CSI status. In some embodiments, the CSI acknowledgment message comprises a session identifier for the channel sounding. In some embodiments, the CSI acknowledgment message comprises information regarding a recommended next action for the access point device to enable the access point to (i) perform channel re-sounding associated with the wireless channel, (ii) withhold from performing channel re-sounding associated with the wireless channel, or (iii) forward the CSI to the apparatus. In some embodiments, the CSI acknowledgment message comprises information regarding a reason for failure associated with the CSI received from the station device.

In some embodiments, transmitting the CSI acknowledgment message comprises transmitting the CSI acknowledgment message in response to a CSI acknowledgment request provided by the access point device. In some embodiments, the CSI acknowledgment request comprises a station identifier for the station device, an identifier for the apparatus 200 (e.g., an access point device) associated with the method 2100, and/or an access point identifier for the access point device. In some embodiments, the CSI acknowledgment request comprises a session identifier for the channel sounding.

In some embodiments, the apparatus 200 additionally or alternatively includes means, such as the processor 205, the memory 210, or the like, configured to determine the CSI acknowledgment policy during or before initiation of coordinated beamforming between the access point device and the apparatus.

In some embodiments, the apparatus 200 additionally or alternatively includes means, such as the processor 205, the memory 210, or the like, configured to transmit the CSI acknowledgment message to the access point device based on a determination that the CSI acknowledgment message corresponds to a positive CSI acknowledgment that indicates that the CSI is satisfies CSI quality criterion.

In some embodiments, the apparatus 200 additionally or alternatively includes means, such as the processor 205, the memory 210, or the like, configured to transmit the CSI acknowledgment message to the access point device based on a determination that the CSI acknowledgment message corresponds to a negative CSI acknowledgment that indicates that the CSI does not satisfy CSI quality criterion.

In some embodiments, the apparatus 200 additionally or alternatively includes means, such as the processor 205, the memory 210, or the like, configured to transmit the CSI acknowledgment message to the access point device in response to the CSI being received from the station device.

In some embodiments, the apparatus 200 additionally or alternatively includes means, such as the processor 205, the memory 210, or the like, configured to transmit the CSI acknowledgment message in response to a CSI acknowledgment request provided by the access point device.

In some embodiments, the apparatus 200 additionally or alternatively includes means, such as the processor 205, the memory 210, or the like, configured to transmit the CSI acknowledgment message to the access point device in response to the CSI being received from the station device and other CSI being received from at least one other station device.

In some embodiments, the apparatus 200 additionally or alternatively includes means, such as the processor 205, the memory 210, or the like, configured to transmit the CSI acknowledgment message for a CSI report received from the station device.

In some embodiments, the apparatus 200 additionally or alternatively includes means, such as the processor 205, the memory 210, or the like, configured to transmit the CSI acknowledgment message to the access point device based on a determination that the CSI satisfies a defined CSI quality threshold value.

In some embodiments, the apparatus 200 additionally or alternatively includes means, such as the processor 205, the memory 210, or the like, configured to transmit the CSI acknowledgment message to the access point device in response to a certain number of CSI retransmissions.

In some embodiments, the CSI acknowledgment message is associated with the station device and one or more other station devices.

In some embodiments, the apparatus 200 additionally or alternatively includes means, such as the processor 205, the memory 210, or the like, configured to transmit the CSI acknowledgment message to the access point device based on a predefined rule regarding priority of the station device.

In some embodiments, the apparatus 200 additionally or alternatively includes means, such as the processor 205, the memory 210, or the like, configured to transmit the CSI acknowledgment message to the access point device based on a predefined rule regarding respective subsets of the CSI.

In some embodiments, the apparatus 200 additionally or alternatively includes means, such as the processor 205, the memory 210, or the like, configured to transmit the CSI acknowledgment message to the access point device in response to a determination that a certain interval of time has passed since the CSI is received from the station device.

In some embodiments, the apparatus 200 additionally or alternatively includes means, such as the processor 205, the memory 210, or the like, configured to transmit the CSI acknowledgment message to the access point device based on a determination that a condition associated with the wireless channel is satisfied.

In some embodiments, the apparatus 200 additionally or alternatively includes means, such as the processor 205, the memory 210, or the like, configured to transmit the CSI acknowledgment message to the access point device (i) in response to receiving the CSI from the station device, (ii) in response to completion of the channel sounding, or (iii) during a network process that is different than the channel sounding.

In some embodiments, a null data packet announcement (NDPA) frame, an acknowledgment frame, a Block Acknowledgement (BA) frame, a management frame, a control frame, or a data frame comprises the CSI acknowledgement message.

In some embodiments, the apparatus 200 additionally or alternatively includes means, such as the processor 205, the memory 210, or the like, configured to receive the CSI acknowledgment request from the access point device (i) in response to receiving the CSI from the station device, (ii) in response to completion of the channel sounding, or (iii) during a network process that is different than the channel sounding.

Referring now to FIG. 22, the operations performed, such as by the apparatus 200 of FIG. 2, in order to enable CSI acknowledgment in coordinated beamforming of a communication network, in accordance with one or more embodiments of the present disclosure. In some embodiments, the method 2200 is associated with functionality of an AP (e.g., AP 110-a). As shown in block 2202 of FIG. 22, the apparatus 200 includes means, such as the processor 205, the memory 210, or the like, configured to determine a channel state information (CSI) acknowledgment policy for a wireless channel in coordination with an access point device.

As shown in block 2204 of FIG. 22, the apparatus 200 additionally or alternatively includes means, such as the processor 205, the memory 210, or the like, configured to control channel sounding for a wireless channel in coordination with the access point device.

As shown in block 2206 of FIG. 22, the apparatus 200 additionally or alternatively includes means, such as the processor 205, the memory 210, or the like, configured to receive a CSI acknowledgment message from the access point device based on the CSI acknowledgment policy.

As shown in block 2208 of FIG. 22, the apparatus 200 additionally or alternatively includes means, such as the processor 205, the memory 210, or the like, configured to determine whether to continue the channel sounding for the wireless channel based on the CSI acknowledgment message.

In some embodiments, the apparatus 200 additionally or alternatively includes means, such as the processor 205, the memory 210, or the like, configured to continue the channel sounding for the wireless channel based on a determination that the CSI acknowledgment message corresponds to a positive CSI acknowledgment.

In some embodiments, the apparatus 200 additionally or alternatively includes means, such as the processor 205, the memory 210, or the like, configured to initiate resounding of the CSI based on a determination that the CSI acknowledgment message corresponds to a negative CSI acknowledgment.

In some embodiments, the apparatus 200 additionally or alternatively includes means, such as the processor 205, the memory 210, or the like, configured to transmit the CSI to the access point device based on a determination that the CSI acknowledgment message corresponds to a negative CSI acknowledgment.

In some embodiments, the CSI acknowledgment message comprises a station identifier for the station device, an identifier for the apparatus 200 (e.g., an access point device) associated with the method 2200, and/or an access point identifier for the access point device. In some embodiments, the CSI acknowledgment message comprises a status indicator regarding the CSI. In some embodiments, the status indicator corresponds to a positive CSI status, a negative CSI status, a partially positive CSI status, or a partially negative CSI status. In some embodiments, the CSI acknowledgment message comprises a session identifier for the channel sounding.

In some embodiments, the apparatus 200 additionally or alternatively includes means, such as the processor 205, the memory 210, or the like, configured to transmit a CSI acknowledgment request to the access point device to request the CSI acknowledgment message. In some embodiments, the CSI acknowledgment request comprises a station identifier for the station device, an identifier for the apparatus 200 (e.g., an access point device) associated with the method 2200, and/or an access point identifier for the access point device. In some embodiments, the CSI acknowledgment request comprises a session identifier for the channel sounding.

In some embodiments, the apparatus 200 additionally or alternatively includes means, such as the processor 205, the memory 210, or the like, configured to determine the CSI acknowledgment policy during or before initiation of coordinated beamforming between the access point device and the apparatus.

In some embodiments, the apparatus 200 additionally or alternatively includes means, such as the processor 205, the memory 210, or the like, configured to receive the CSI acknowledgment message from the access point device based on a determination that the CSI acknowledgment message corresponds to a positive CSI acknowledgment that indicates that the CSI is satisfies CSI quality criterion.

In some embodiments, the apparatus 200 additionally or alternatively includes means, such as the processor 205, the memory 210, or the like, configured to receive the CSI acknowledgment message from the access point device based on a determination that the CSI acknowledgment message corresponds to a negative CSI acknowledgment that indicates that the CSI does not satisfy CSI quality criterion.

In some embodiments, the apparatus 200 additionally or alternatively includes means, such as the processor 205, the memory 210, or the like, configured to receive the CSI acknowledgment message from the access point device in response to the CSI being received from the station device.

In some embodiments, the apparatus 200 additionally or alternatively includes means, such as the processor 205, the memory 210, or the like, configured to receive the CSI acknowledgment message from the access point device in response to a CSI acknowledgment request provided by the access point device.

In some embodiments, the apparatus 200 additionally or alternatively includes means, such as the processor 205, the memory 210, or the like, configured to receive the CSI acknowledgment message from the access point device in response to the CSI being received from the station device and other CSI being received from at least one other station device.

In some embodiments, the apparatus 200 additionally or alternatively includes means, such as the processor 205, the memory 210, or the like, configured to receive the CSI acknowledgment message for a CSI report received from the station device.

In some embodiments, the apparatus 200 additionally or alternatively includes means, such as the processor 205, the memory 210, or the like, configured to receive the CSI acknowledgment message from the access point device based on a determination that the CSI satisfies a defined CSI quality threshold value.

In some embodiments, the apparatus 200 additionally or alternatively includes means, such as the processor 205, the memory 210, or the like, configured to receive the CSI acknowledgment message from the access point device in response to a certain number of CSI retransmissions.

In some embodiments, the CSI acknowledgment message is associated with the station device and one or more other station devices.

In some embodiments, the apparatus 200 additionally or alternatively includes means, such as the processor 205, the memory 210, or the like, configured to receive the CSI acknowledgment message from the access point device based on a predefined rule regarding priority of the station device.

In some embodiments, the apparatus 200 additionally or alternatively includes means, such as the processor 205, the memory 210, or the like, configured to receive the CSI acknowledgment message from the access point device based on a predefined rule regarding respective subsets of the CSI.

In some embodiments, the apparatus 200 additionally or alternatively includes means, such as the processor 205, the memory 210, or the like, configured to receive the CSI acknowledgment message from the access point device in response to a determination that a certain interval of time has passed since the CSI is received from the station device.

In some embodiments, the apparatus 200 additionally or alternatively includes means, such as the processor 205, the memory 210, or the like, configured to receive the CSI acknowledgment message from the access point device based on a determination that a condition associated with the wireless channel is satisfied.

In some embodiments, the apparatus 200 additionally or alternatively includes means, such as the processor 205, the memory 210, or the like, configured to perform a next action based on a recommendation included in the CSI acknowledgment message.

In some embodiments, the apparatus 200 additionally or alternatively includes means, such as the processor 205, the memory 210, or the like, configured to receive the CSI acknowledgment message from the access point device (i) in response to the access point device receiving the CSI from the station device, (ii) in response to completion of the channel sounding, or (iii) during a network process that is different than the channel sounding.

In some embodiments, a null data packet announcement (NDPA) frame, an acknowledgment frame, a Block Acknowledgement (BA) frame, a management frame, a control frame, or a data frame comprises the CSI acknowledgement message.

In some embodiments, the CSI acknowledgment request comprises a CSI acknowledgment policy for the channel sounding. In some embodiments, the CSI acknowledgment policy indicates criteria for transmission of the CSI acknowledgment message.

In some embodiments, the apparatus 200 additionally or alternatively includes means, such as the processor 205, the memory 210, or the like, configured to transmit the CSI acknowledgment request to the access point device (i) in response to the access point device receiving the CSI from the station device, (ii) in response to completion of the channel sounding, or (iii) during a network process that is different than the channel sounding.

As described above, FIGS. 17-22 are flowcharts of various methods that can be carried out by, e.g., the apparatus 200, and/or according to a computer program product, according to an example embodiment of the disclosure. A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as, e.g., in conjunction with the communications flowchart of FIG. 17, communications flowchart of FIG. 18, communications flowchart of FIG. 19, communications flowchart of FIG. 20, communications flowchart of FIG. 21, and communications flowchart of FIG. 22, as part of the communication system of FIG. 1, as part of the signaling flow diagram of FIG. 3, as part of the signaling flow diagram of FIG. 4, and/or as part of the signaling flow diagram of FIG. 5. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments presented herein and that modifications and other embodiments are intended to be included within the scope of the appended claims. Although specific terms are employed herein, they are used in a generic and descriptive sense only and not for purposes of limitation.

1. An apparatus comprising:
at least one processor; and
at least one memory storing instructions that, when executed by the at least one processor, cause the apparatus to:
transmit a null data packet to a station device in response to initiation of channel sounding for a wireless channel by an access point device;
receive channel state information (CSI) from the station device based on the null data packet;
receive a CSI acknowledgment request from the access point device; and
based on the CSI acknowledgment request, transmit a CSI acknowledgment message associated with the channel sounding.

2. The apparatus of claim 1, further configured to:
transmit the CSI acknowledgment message to the access point device or the station device to (i) enable continuation of the channel sounding, (ii) initiate re-sounding associated with the CSI, or (iii) provide a recommend next action for the access point device.

3. The apparatus of claim 1, wherein the CSI acknowledgment request comprises at least one of the following:
a station identifier for the station device,
an identifier for the apparatus, or
an access point identifier for the access point device.

4. The apparatus of claim 1, wherein the CSI acknowledgment request comprises a session identifier for the channel sounding.

5. The apparatus of claim 1, wherein the CSI acknowledgment request comprises a CSI acknowledgment policy for the channel sounding.

6. The apparatus of claim 5, wherein the CSI acknowledgment policy indicates criteria for transmission of the CSI acknowledgment message.

7. The apparatus of claim 1, wherein a Block Acknowledgment Request (BAR) frame, a null data packet announcement (NDPA) frame comprises the CSI acknowledgment request, a beamforming report poll (BFRP) frame comprises the CSI acknowledgment request, a management frame, a control frame, or a data frame comprises the CSI acknowledgment request.

8. The apparatus of claim 1, further configured to:
receive the CSI acknowledgment request from the access point device (i) in response to receiving the CSI from the station device, (ii) in response to completion of the channel sounding, or (iii) during a network process that is different than the channel sounding.

9. An apparatus comprising:
at least one processor; and
at least one memory storing instructions that, when executed by the at least one processor, cause the apparatus to:
control channel sounding for a wireless channel in coordination with an access point device;
transmit a channel state information (CSI) acknowledgment request to the access point device;
receive a CSI acknowledgment message from the access point device in response to the CSI acknowledgment request; and
determine whether to continue the channel sounding for the wireless channel based on the CSI acknowledgment message.

10. The apparatus of claim 9, further configured to:
continue the channel sounding for the wireless channel based on a determination that the CSI acknowledgment message corresponds to a positive CSI acknowledgment.

11. The apparatus of claim 9, further configured to:
initiate resounding of the CSI based on a determination that the CSI acknowledgment message corresponds to a negative CSI acknowledgment.

12. The apparatus of claim 9, further configured to:
perform a next action based on a recommendation included in the CSI acknowledgment message.

13. The apparatus of claim 9, further configured to:
transmit the CSI to the access point device based on a determination that the CSI acknowledgment corresponds to a negative CSI acknowledgment.

14. The apparatus of claim 9, further configured to:
transmit the CSI acknowledgment request to the access point device via a Block Acknowledgment Request (BAR) frame, a null data packet announcement (NDPA) frame, or a beamforming report poll (BFRP) frame, a management frame, a control frame, or a data frame.

15. The apparatus of claim 9, wherein the CSI acknowledgment request comprises at least one of the following:
a station identifier for the station device,
an identifier for the apparatus, or
an access point identifier for the access point device.

16. The apparatus of claim 9, wherein the CSI acknowledgment request comprises a session identifier for the channel sounding.

17. The apparatus of claim 9, wherein the CSI acknowledgment request comprises a CSI acknowledgment policy for the channel sounding.

18. The apparatus of claim 17, wherein the CSI acknowledgment policy indicates criteria for transmission of the CSI acknowledgment message.

19. The apparatus of claim 9, further configured to:
transmit the CSI acknowledgment request to the access point device (i) in response to the access point device receiving the CSI from the station device, (ii) in response to completion of the channel sounding, or (iii) during a network process that is different than the channel sounding.

20. A method comprising:
transmitting a null data packet to a station device in response to initiation of channel sounding for a wireless channel by an access point device;
receiving channel state information (CSI) from the station device based on the null data packet;
receiving a CSI acknowledgment request from the access point device; and
based on the CSI acknowledgment request, transmitting a CSI acknowledgment message associated with the channel sounding.
